(19) United States
(12) Patent Application Publication
(10) Pub. No.: US 2018/0126472 A1
(43) Pub. Date: May 10, 2018

(54) GEAR MACHINING DEVICE AND GEAR MACHINING METHOD

(71) Applicant: JTEKT CORPORATION, Osaka-shi (JP)

(72) Inventors: Lin Zhang, Nagoya-shi (JP); Hisashi Otani, Anjo-shi (JP); Hiroyuki Nakano, Tokai-shi (JP); Kento Takeuchi, Kariya-shi (JP)

(73) Assignee: JTEKT CORPORATION, Osaka-shi (JP)

(21) Appl. No.: 15/803,241

(22) Filed: Nov. 3, 2017

(30) Foreign Application Priority Data
Nov. 4, 2016 (JP) 2016-216679
Nov. 4, 2016 (JP) 2016-216680
Jul. 21, 2017 (JP) 2017-142178

(51) Int. Cl. B23F 19/00; B23F 19/10; B23F 17/00; B23F 21/14

(52) U.S. Cl. CPC B23F 19/005; B23F 19/102; B23F 23/1237; B23F 21/14; B23F 17/001

(57) ABSTRACT

To provide a gear machining device and a gear machining method which achieve machining of tooth flanks having different torsion angles with high degree of accuracy. In a gear machining device, a side surface of a tooth of a gear includes a first tooth flank and a second tooth flank having a different torsion angle from the first tooth flank, a cutting blade of a machining tool has a blade traces having a torsion angle determined based on a torsion angle of the second tooth flank and an intersection angle between a rotation axis of a workpiece and a rotation axis of the machining tool so as to allow the second tooth flank to be machined on the pre-machined first tooth flank.

### CROSS REFERENCE TO RELATED APPLICATIONS

This application claims priority based on Japanese Patent Application No. 2016-216679 filed on Nov. 4, 2016, Japanese Patent Application No. 2016-216680 filed on Nov. 4, 2016, and Japanese Patent Application No. 2017-142178 filed on Jul. 21, 2017, the entire contents of which are incorporated by reference herein.

### BACKGROUND OF THE INVENTION

### Technical Field

The present invention relates to a gear machining device and a gear machining method for machining gears by cutting workpieces while rotating a machining tool and a workpiece synchronously.

### Background Art

Transmissions used in vehicles are provided with a synchromesh mechanism for a smooth gear shift operation. As illustrated in FIG. 21, a key-type synchromesh mechanism 110 includes a main shaft 111, a main drive shaft 112, a clutch hub 113, keys 114, a sleeve 115, a main drive gear 116, a clutch gear 117, and a synchronizer ring 118.

The main shaft 111 and the main drive shaft 112 are coaxially arranged. The clutch hub 113 is spline-fitted to the main shaft 111, so that the main shaft 111 and the clutch hub 113 rotate together. The keys 114 are supported at three points on an outer periphery of the clutch hub 113 with a spring which is not illustrated. The sleeve 115 has inner teeth (spline) 115a on an inner periphery thereof, and the sleeve 115 slides in a direction of a rotation axis LL along the splines, which are not illustrated, formed on the outer periphery of the clutch hub 113 together with the keys 114.

The main drive gear 116 is fitted on the main drive shaft 112, and the main drive gear 116 is integrally provided with the clutch gear 117 having a tapered cone 117b projecting therefrom on the sleeve 115 side. Disposed between the sleeve 115 and the clutch gear 117 is the synchronizer ring 118. Outer teeth 117a of the clutch gear 117 and outer teeth 118a of the synchronizer ring 118 are formed so as to be engageable with the inner teeth 115a of the sleeve 115. An inner periphery of the synchronizer ring 118 is formed into a tapered shape which is frictionally engageable with the outer periphery of the tapered cone 117b.

An operation of the synchromesh mechanism 110 will be described now. As illustrated in FIG. 22A, the sleeve 115 and the keys 114 are moved in the direction of the rotation axis LL indicated by an arrow in the drawing by an operation of the shift lever, which is not illustrated. The keys 114 pushes the synchronizer ring 118 in the direction of the rotation axis LL to press the inner periphery of the synchronizer ring 118 against the outer periphery of the tapered cone 117b. Accordingly, the clutch gear 117, the synchronizer ring 118, and the sleeve 115 start rotating synchronously.

As illustrated in FIG. 22B, the keys 114 are pushed downward by the sleeve 115 and thus presses the synchronizer ring 118 further in the direction of the rotation axis LL. Consequently, as the degree of contact between the inner periphery of the synchronizer ring 118 and the outer periphery of the tapered cone 117b is increased and a strong frictional force is generated, the clutch gear 117, the synchronizer ring 118 and the sleeve 115 rotate synchronously. When the number of rotations of the clutch gear 117 and the number of rotations of the sleeve 115 are completely synchronized, the frictional force between the inner periphery of the synchronizer ring 118 and the outer periphery of the tapered cone 117b disappears.

When the sleeve 115 and the keys 114 move further toward the rotation axis LL as indicated by an arrow in the drawing, the keys 114 fit into grooves 118b of the synchronizer ring 118 and stop. However, the sleeve 115 moves beyond projecting portions 114a of the keys 114, and the inner teeth 115a of the sleeve 115 engage the outer teeth 118a of the synchronizer ring 118. As illustrated in FIG. 22C, the sleeve 115 further moves in the direction of the rotation axis LL, where the inner teeth 115a of the sleeve 115 engage outer teeth 117a of the clutch gear 117. In this action, gear shift is completed.

The synchromesh mechanism 110 as described above is provided with a tapered gear coming-off preventing portion 120 on each of the inner teeth 115a of the sleeve 115 and a tapered gear coming-off preventing portion 117c that taper-fits the gear coming-off preventing portion 120 on each of the outer teeth 117a of the clutch gear 117 as illustrated in FIG. 23 and FIG. 24 for preventing the outer teeth 117a of the clutch gear 117 and the inner teeth 115a of the sleeve 115 from coming off during traveling. In the following description, a side surface 115A of the inner tooth 115a of the sleeve 115 on the left side of the drawing is referred to as “left side surface 115A” and a side surface 115B of the inner tooth 115a of the sleeve 115 on the right side of the drawing is referred to as “right side surface 115B”.

The left side surface 115A of the inner tooth 115a of the sleeve 115 has a left tooth flank 115b (which corresponds to “first tooth flank” of the invention) and a tooth flank 121 having a torsion angle different from the left tooth flank 115b (hereinafter, referred to as a left tapered tooth flank 121, which corresponds to “second tooth flank” of the invention). The right side surface 115B of the inner tooth 115a of the sleeve 115 has a right tooth flank 115c (which corresponds to “third tooth flank” or “first tooth flank” of the invention) and a tooth flank 122 having a torsion angle different from the right tooth flank 115c (hereinafter, referred to as “right tapered tooth flank 122”, which corresponds to “fourth tooth flank” or “second tooth flank” of the invention).

In this example, the torsion angle of the left tooth flanks 115b is 0 degree, the torsion angle of the left tapered tooth flanks 121 is θf degrees, the torsion angle of the right tooth flanks 115c is 0 degree, and the torsion angle of the right tapered tooth flanks 122 is θr degrees. The left tapered tooth flank 121 and a tooth flank 121a that connects the left tapered tooth flank 121 and the left tooth flank 115b (hereinafter, referred to as “left sub tooth flank 121a”), and the right tapered tooth flank 122 and a tooth flank 122a that connects the right tapered tooth flank 122 and the right tooth flank 115c (hereinafter, referred to as “right sub tooth flank 122a”) constitute the gear coming-off preventing portion 120. The gear coming-off prevention is achieved by taper fitting between the left tapered tooth flanks 121 and the gear coming-off preventing portions 117c.

In this manner, the structure of the inner teeth 115a of the sleeve 115 is complicated, and the sleeve 115 is a component which requires mass production. Therefore, the inner teeth 115a of the sleeve 115 are formed generally by broaching, gear shapering, or the like, and the gear coming-off preventing portions 120 are formed by rolling (see JP-UM-6-61340, JP-A-2005-152940).

In order to ensure the above-described gear coming-off prevention in the synchromesh mechanism 110, the gear coming-off preventing portions 120 of the inner teeth 115a of the sleeve 115 need to be machined with high degree of accuracy. However, since the gear coming-off preventing portions 120 are formed by rolling, which is plastic forming, the accuracy of machining tends to be lowered.

### SUMMARY OF THE INVENTION

In view of such circumstances, it is an object of the invention to provide a gear machining device and a gear machining method which achieve machining of tooth flanks having different torsion angles with high degree of accuracy.

A gear machining device of the invention is a gear machining device configured to use a machining tool having a rotation axis inclined with respect to a rotation axis of a workpiece and machine a gear by feeding the machining tool relatively in the direction of the rotation axis of the workpiece with respect to the workpiece while rotating the machining tool and the workpiece synchronously, wherein a side surface of a gear tooth includes a first tooth flank and a second tooth flank having a torsion angle different from the first tooth flank, a blade trace of the cutting blade of the machining tool having a torsion angle determined based on a torsion angle of the second tooth flank and an intersection angle between the rotation axis of the workpiece and the rotation axis of the machining tool so as to allow the second tooth flank to be machined on the pre-machined first tooth flank.

In the related art, the second tooth flank of the gear tooth having the first tooth flank and the second tooth flank at different torsion angles is formed on the pre-machined first tooth flank by plastic forming. Therefore, a problem of lowering of machining accuracy of the second tooth flank exists. However, in this gear machining device, the second tooth flank is formed on the first tooth flank by cutting, high degree of accuracy is achieved.

A gear machining method of the invention is a gear machining method for machining a gear with a machining tool, wherein the gear including a tooth having a side surface including a first tooth flank and a second tooth flank having a torsion angle different from the first tooth flank, the machining tool including a cutting blade having a blade trace having a torsion angle determined based on a torsion angle of the second tooth flank and an intersection angle between the rotation axis of the workpiece and the rotation axis of the machining tool so as to allow the second tooth flank to be machined on the pre-machined first tooth flank, the gear machining method including: a step of inclining the rotation axis of the machining tool with respect to the rotation axis of the workpiece, and a step of machining the second tooth flank by feeding the machining tool with respect to the workpiece in the direction of the rotation axis while rotating synchronously with the workpiece. Accordingly, the same advantageous effects as the above-described gear machining device are achieved.

### BRIEF DESCRIPTION OF DRAWINGS

FIG. 1 is a drawing illustrating a general configuration of a gear machining device according to an embodiment of the invention;

FIG. 2 is a flowchart for describing a tool designing process to be performed by a control apparatus in FIG. 1 for a tapered tooth flank machining tool;

FIG. 3 is a flowchart for describing a tool state setting process to be performed by the control apparatus in FIG. 1;

FIG. 4 is a flowchart for describing a machining control process with the tapered tooth flank machining tool to be performed by the control apparatus in FIG. 1;

FIG. 5A is a drawing illustrating a schematic configuration of the machining tool when viewed in a direction of a rotation axis from a tool end surface side;

FIG. 5B is a partial cross-sectional view illustrating the machining tool in FIG. 5A viewed in a radial direction;

FIG. 5C is an enlarged view of a cutting blade of the machining tool in FIG. 5B;

FIG. 6A is a drawing illustrating a dimensional relationship between the machining tool and a workpiece when designing the tapered tooth flank machining tool;

FIG. 6B is a drawing illustrating a positional relationship between the machining tool and the workpiece when designing the tapered tooth flank machining tool;

FIG. 7 is a drawing illustrating respective portions of the machining tool used when obtaining a cutting edge width and a blade thickness of the machining tool;

FIG. 8A is a drawing illustrating a schematic configuration of the machining tool for machining a left tapered tooth flank viewed in the radial direction;

FIG. 8B is a drawing illustrating a schematic configuration of the machining tool for machining a right tapered tooth flank in the radial direction;

FIG. 9A is a drawing illustrating a positional relationship between the machining tool and the workpiece when changing the tool position of the machining tool in the direction of the rotation axis;

FIG. 9B is a first drawing illustrating a machining state when an axial position is changed;

FIG. 9C is a second drawing illustrating a machining state when the axial position is changed;

FIG. 9D is a third drawing illustrating a machining state when the axial position is changed;

FIG. 10A is a drawing illustrating a positional relationship between the machining tool and the workpiece when changing an intersection angle which indicates an inclination of the rotation axis of the machining tool with respect to a rotation axis of the workpiece;

FIG. 10B is a first drawing illustrating a machining state when the intersection angle is changed;

FIG. 10C is a second drawing illustrating a machining state when the intersection angle is changed;

FIG. 10D is a third drawing illustrating a machining state when the intersection angle is changed;

FIG. 11A is a drawing illustrating a positional relationship between the machining tool and the workpiece when changing the position of the machining tool in the direction of the rotation axis and the intersection angle;

FIG. 11B is a first drawing illustrating a machining state when the axial position and the intersection angle are changed;

FIG. 11C is a second drawing illustrating a machining state when the axial position and the intersection angle are changed;

FIG. 12A is a drawing illustrating a position of the machining tool before machining the left tapered tooth flank viewed in the radial direction;

FIG. 12B is a drawing illustrating a position of the machining tool when machining the left tapered tooth flank viewed in the radial direction;

FIG. 12C is a drawing illustrating a position of the machining tool after the left tapered tooth flank is machined viewed in the radial direction;

FIG. 13 is a flowchart for describing a tool designing process to be performed by a control apparatus in FIG. 1 for a tapered tooth flank machining tool of an alternative example;

FIG. 14A is a drawing illustrating a dimensional relationship between the machining tool and the workpiece when designing a left blade surface of the tapered tooth flank machining tool of the alternative example;

FIG. 14B is a drawing illustrating a positional relationship between the machining tool and the workpiece when designing the tapered tooth flank machining tool of the alternative example;

FIG. 14C is a drawing illustrating a dimensional relationship between the machining tool and the workpiece when designing a right blade surface of the tapered tooth flank machining tool of the alternative example;

FIG. 15 is a flowchart for describing a tool designing process to be performed by a control apparatus in FIG. 1 for a chamfered tooth flank machining tool;

FIG. 16A is a drawing illustrating a dimensional relationship between the machining tool and the workpiece when designing the chamfered tooth flank machining tool;

FIG. 16B is a drawing illustrating a positional relationship between the machining tool and the workpiece when designing the chamfered tooth flank machining tool;

FIG. 17A is a drawing illustrating a schematic configuration of a left chamfered tooth flank machining tool viewed in the radial direction;

FIG. 17B is a drawing illustrating a schematic configuration of aright chamfered tooth flank machining tool viewed in the radial direction;

FIG. 18 is a drawing illustrating a cutting blade of the right chamfered tooth flank machining tool viewed in an axial direction;

FIG. 19A is a drawing illustrating a dimensional relationship between the machining tool and the workpiece when designing a left blade surface of a chamfered tooth flank machining tool of an alternative example;

FIG. 19B is a drawing illustrating a positional relationship between the machining tool and the workpiece when designing the chamfered tooth flank machining tool of the alternative example;

FIG. 19C is a drawing illustrating a dimensional relationship between the machining tool and the workpiece when designing a right blade surface of the chamfered tooth flank machining tool of the alternative example;

FIG. 20 is a perspective view illustrating burrs generating on a sleeve as a workpiece;

FIG. 21 is a cross-sectional view illustrating a synchromesh mechanism having the sleeve as a workpiece;

FIG. 22A is a cross-sectional view illustrating a state of the synchromesh mechanism in FIG. 21 before starting operation;

FIG. 22B is a cross-sectional view illustrating a state of the synchromesh mechanism in FIG. 21 during operation;

FIG. 22C is a cross-sectional view illustrating a state of the synchromesh mechanism in FIG. 21 after completion of operation;

FIG. 23 is a perspective view illustrating a gear coming-off preventing portion of the sleeve as a workpiece;

FIG. 24 is a drawing of the gear coming-off preventing portion of the sleeve in FIG. 23 viewed in the radial direction;

FIG. 25 is a perspective view illustrating a gear coming-off preventing portion of a first modification of the sleeve as a workpiece;

FIG. 26 is a drawing of the gear coming-off preventing portion of the sleeve in FIG. 25 viewed in the radial direction;

FIG. 27 is a flowchart for describing a tool designing process for a tapered tooth flank machining tool to be performed by a control apparatus in FIG. 1 for machining the gear coming-off preventing portion in FIG. 38;

FIG. 28A is a flowchart for describing a machining control process to be performed by the control apparatus in FIG. 1 with the tapered tooth flank machining tool for machining the gear coming-off preventing portion in FIG. 38;

FIG. 28B is a flowchart continuing from the flow in FIG. 28A for describing the machining control process to be performed by the control apparatus in FIG. 1 with the tapered tooth flank machining tool for machining the gear coming-off preventing portion in FIG. 38;

FIG. 29A is a drawing of a schematic configuration of the tapered tooth flank machining tool for machining the gear coming-off preventing portion in FIG. 38 when viewed in the direction of the rotation axis from a tool end surface side;

FIG. 29B is a partial cross-sectional view illustrating the schematic configuration of the tapered tooth flank machining tool in FIG. 29A viewed in the radial direction;

FIG. 29C is an enlarged view of a cutting blade of the tapered tooth flank machining tool in FIG. 29B;

FIG. 30 is a perspective view illustrating a collar which constitutes the tapered tooth flank machining tool in FIG. 29B;

FIG. 31 is drawing illustrating a state in which the tapered tooth flank machining tool in FIG. 29B is assembled to a tool holder and a rotary main spindle;

FIG. 32 is a drawing illustrating a schematic configuration of a first tool (second tool) of the tapered tooth flank machining tool in FIG. 29B viewed in the radial direction;

FIG. 33A is a first drawing illustrating a dimensional relationship between the tapered tooth flank machining tool and the workpiece when designing the first tool of the tapered tooth flank machining tool in FIG. 29B;

FIG. 33B is a first drawing illustrating a positional relationship between the tapered tooth flank machining tool and the workpiece when designing the first tool of the tapered tooth flank machining tool in FIG. 29B;

FIG. 33C is a second drawing illustrating a dimensional relationship between the tapered tooth flank machining tool and the workpiece when designing the first tool of the tapered tooth flank machining tool in FIG. 29B;

FIG. 33D is a second drawing illustrating a positional relationship between the tapered tooth flank tool and the workpiece when designing the first machining tool of the tapered tooth flank machining tool in FIG. 29B;

FIG. 34A is a drawing illustrating a position of the tapered tooth flank machining tool in FIG. 29B before machining the other-side left tapered tooth flank viewed in the radial direction;

FIG. 34B is a drawing illustrating a position of the tapered tooth flank machining tool in FIG. 29B when machining the other-side left tapered tooth flank viewed in the radial direction;

FIG. 34C is a drawing illustrating a position of the tapered tooth flank machining tool in FIG. 29B after the other-side left tapered tooth flank is machined viewed in the radial direction;

FIG. 35A is a second drawing illustrating a dimensional relationship between the tapered tooth flank machining tool and the workpiece when designing the second tool of the tapered tooth flank machining tool in FIG. 29B;

FIG. 35B is a second drawing illustrating a positional relationship between the tapered tooth flank machining tool and the workpiece when designing the second tool of the tapered tooth flank machining tool in FIG. 29B;

FIG. 36A is a drawing illustrating a position of the tapered tooth flank machining tool in FIG. 29B before machining one-side left tapered tooth flank viewed in the radial direction;

FIG. 36B is a drawing illustrating a position of the tapered tooth flank machining tool in FIG. 29B when machining the one-side left tapered tooth flank viewed in the radial direction;

FIG. 36C is a drawing illustrating a position of the tapered tooth flank machining tool in FIG. 29B after the one-side left tapered tooth flank is machined viewed in the radial direction;

FIG. 37 is a cross-sectional view illustrating a synchromesh mechanism having the sleeve of a second modification as a workpiece;

FIG. 38 is a perspective view illustrating a gear coming-off preventing portion of the sleeve in FIG. 37; and

FIG. 39 is a drawing of the gear coming-off preventing portion of the sleeve in FIG. 37 viewed in the radial direction.

### DETAILED DESCRIPTION OF INVENTION

### 1. Mechanical Configuration of Gear Machining Device

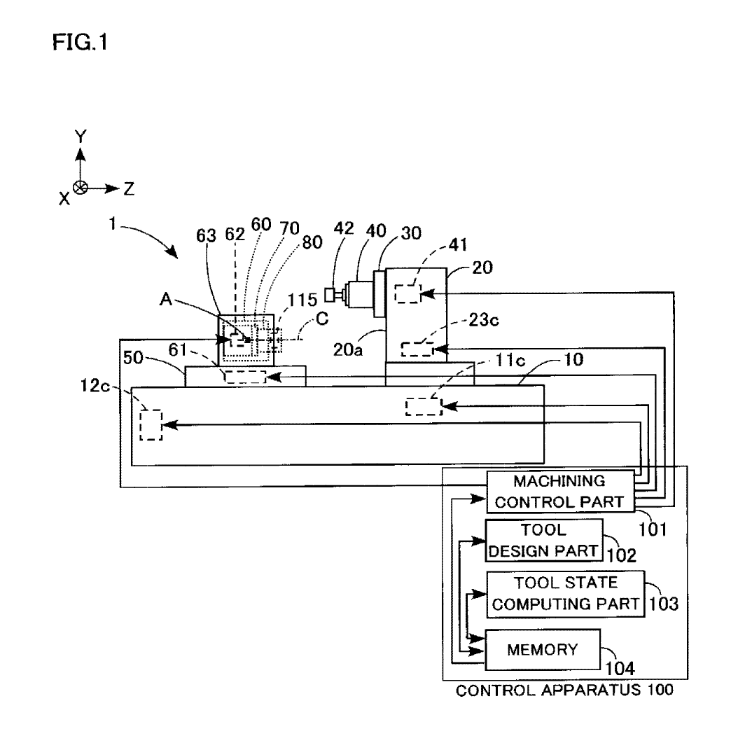

In this embodiment, a five-axis machining center is exemplified as an example of the gear machining device, and will be described with reference to FIG. 1. In other word, the gear machining device 1 is a device having drive axes including three rectilinear axes (X, Y, and Z axes) orthogonal to each other and two rotation axes (an A-axis parallel to an X-axis and a C axis perpendicular to the A-axis).

Here, as described in Background Art, gear coming-off preventing portions 120 are formed by rolling, which is plastic forming, on the inner teeth 115a of the sleeve 115 formed by broaching or gear shapering. Therefore, machining accuracy tends to be lowered. Therefore, the above-described gear machining device 1 firstly forms the inner teeth 115a of the sleeve 115 by broaching, gear shapering, or the like, and then forms the gear coming-off preventing portions 120 on the inner teeth 115a of the sleeve 115 respectively by cutting by means of a machining tool 42 described later.

In other words, the gear coming-off preventing portions 120 are formed by rotating the sleeve 115 having the inner teeth 115a formed thereon and the machining tool 42 synchronously and cutting the sleeve 115 while feeding the machining tool 42 in a direction of a rotation axis of the sleeve 115. Accordingly, the gear coming-off preventing portions 120 are machined with high degree of accuracy.

As illustrated in FIG. 1, the gear machining device 1 includes a bed 10, a column 20, a saddle 30, a rotary main spindle 40, a table 50, a tilt table 60, a turn table 70, a workpiece holder 80, and a control apparatus 100. Although the illustrating is omitted, a known automatic tool replacement device is provided next to the bed 10.

The bed 10 is formed into a substantially rectangular shape and is disposed on a floor. An X-axis ball screw, which is not illustrated, for driving the column 20 in a direction parallel to the X-axis is disposed on an upper surface of the bed 10. In addition, an X-axis motor 11c configured to drive the X-axis ball screw to rotate is disposed on the bed 10.

A Y-axis ball screw, which is not illustrated, for driving the saddle 30 in a direction parallel to the Y-axis is disposed on a side surface (sliding surface) 20a of the column 20 parallel to the Y-axis. A Y-axis motor 23c configured to drive the Y-axis ball screw to rotate is disposed in the column 20.

The rotary main spindle 40 supports the machining tool 42, is rotatably supported in the saddle 30, and is rotated by a spindle motor 41 accommodated in the saddle 30. The machining tool 42 is held on the tool holder, which is not illustrated, is fixed to a distal end of the rotary main spindle 40, and is rotated in association with the rotation of the rotary main spindle 40. The machining tool 42 moves with respect to the bed 10 in a direction parallel to the X-axis and in the direction parallel to the Y-axis in association with the movements of the column 20 and the saddle 30. Detailed description of the machining tool 42 will be given later.

A Z-axis ball screw, which is not illustrated, for driving the table 50 in a direction parallel to the Z-axis is disposed on the upper surface of the bed 10. A Z-axis motor 12c configured to drive the Z-axis ball screw to rotate is disposed on the bed 10.

The table 50 is provided with tilt table support portions 63 configured to support the tilt table 60 on an upper surface thereof. The tilt table support portions 63 is provided with the tilt table 60 so as to be rotatable (pivotable) about an axis parallel to the A-axis. The tilt table 60 is rotated (pivoted) by an A-axis motor 61 accommodated in the table 50.

The tilt table 60 is provided with the turn table 70 so as to be rotatable about an axis which is parallel to the C-axis. The workpiece holder 80 configured to hold the sleeve 115 as a workpiece is mounted on the turn table 70. The turn table 70 is rotated by a C-axis motor 62 together with the sleeve 115 and the workpiece holder 80.

The control apparatus 100 includes a machining control part 101, a tool design part 102, a tool state computing part 103, and a memory 104. Here, each of the machining control part 101, the tool design part 102, the tool state computing part 103, and the memory 104 may be configured as individual hardware, or may be configured as software, respectively.

The machining control part 101 cuts the sleeve 115 by controlling the spindle motor 41 to rotate the machining tool 42, controlling the X-axis motor 11c, the Z-axis motor 12c, the Y-axis motor 23c, the A-axis motor 61, and the C-axis motor 62 to move the sleeve 115 and the machining tool 42 relative to each other in the direction parallel to the X-axis direction, in the direction parallel to the Z-axis direction, in the direction parallel to the Y-axis direction, about the axis parallel to the A-axis, and about the axis parallel to the C-axis.

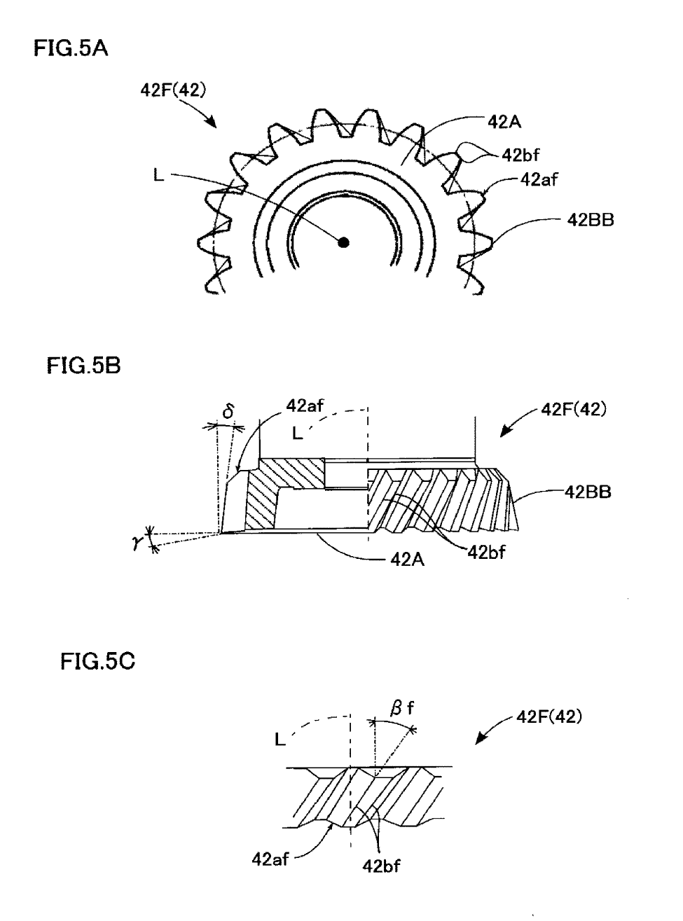

The tool design part 102, as will be described later in detail, obtains a torsion angle βf (see FIG. 5C) and the like of the cutting blade 42a of the machining tool 42 to design the machining tool 42.

The tool state computing part 103, as will be described later in detail, computes a tool state, which is a relative position and a posture of the machining tool 42 with respect to the sleeve 115.

In the memory 104, tool data relating to the machining tool 42 such as a cutting edge circle diameter da, a reference circle diameter d, an addendum ha, a module m, an addendum modification coefficient λ, a pressure angle α, a front pressure angle αt, and cutting edge pressure angle αa, as well as machining data for cutting the sleeve 115 are stored in advance. In the memory 104, a number of blades Z of the cutting blade 42a to be input when designing the machining tool 42 or the like is stored, and shape data of the machining tool 42 designed by the tool design part 102 and the tool state computed by the tool state computing part 103 are also stored.

### 2. Machining Tool

In this example, a case of forming a left tapered tooth flanks 121 each including the left sub tooth flank 121a and a right tapered tooth flanks 122 each including a right sub tooth flanks 122a which constitute the gear coming-off preventing portions 120 of the sleeve 115 respectively by cutting with two machining tools 42 will be described. In the following description, a case of designing the machining tool 42 (hereinafter, referred to as “first machining tool 42F”) for cutting the left tapered tooth flanks 121 will be described. However, as the same applies to a case of designing the machining tool 42 (hereinafter, referred to as “second machining tool 42G”) for cutting the right tapered tooth flanks 122, detailed description will be omitted.

As illustrated in FIG. 5A, the cutting blades 42af when viewing the first machining tool 42F in a direction of a tool axis (rotation axis) L from a tool end surface 42A side in this example is the same shape as an involute curve shape. As illustrated in FIG. 5B, the cutting blade 42af of the first machining tool 42F has a rake angle inclined by an angle γ with respect to a plane perpendicular to the tool axis L on the tool end surface 42A side, and a front clearance angle inclined by an angle δ with respect to a straight line parallel to the tool axis L on a tool peripheral surface 42BB side. As illustrated in FIG. 5C, blade traces 42bf of the cutting blade 42af have a torsion angle inclined by an angle βf with respect to a straight line parallel to the tool axis L.

As described above, the left tapered tooth flanks 121 of the sleeve 115 are formed by cutting the inner teeth 115a of the sleeve 115 which are already formed by the first machining tool 42F. Therefore, the cutting blade 42af of the first machining tool 42F needs to have a shape which definitely allows the left tapered tooth flanks 121 including the left sub tooth flanks 121a to be cut without interference with the adjacent inner teeth 115a while cutting the inner teeth 115a.

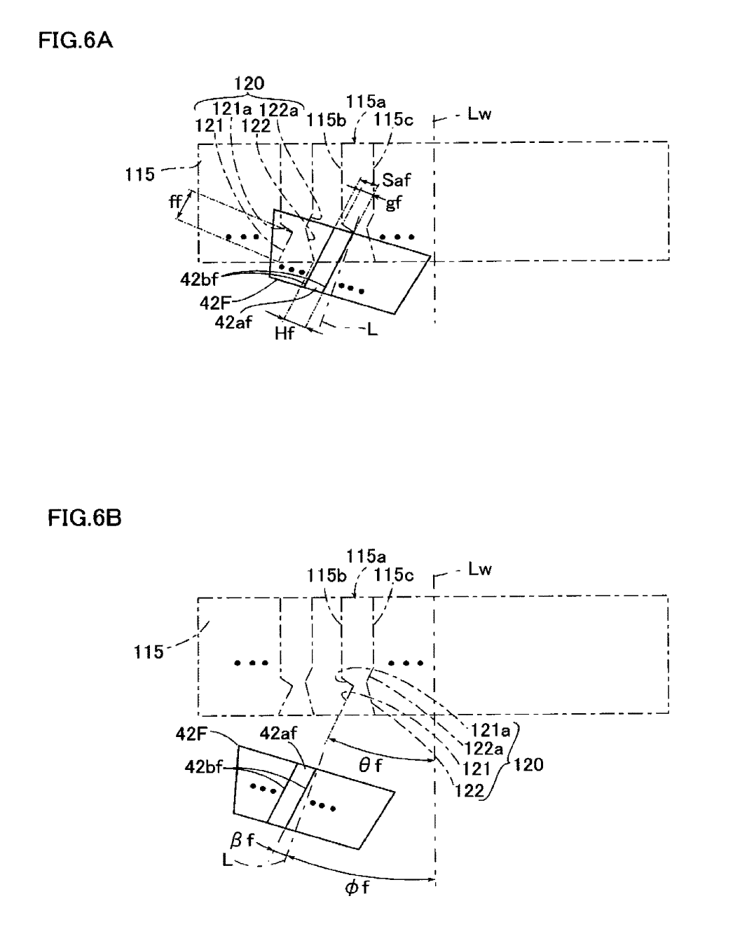

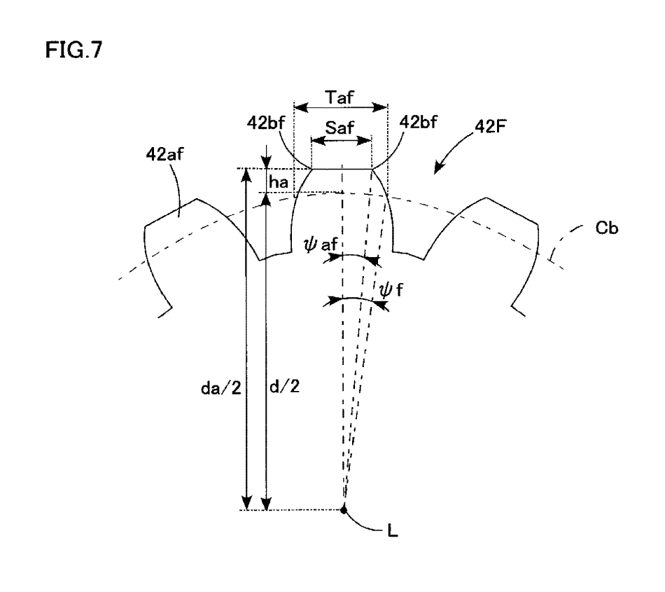

Specifically, as illustrated in FIG. 6A, the cutting blade 42af is required to be designed so as to make a cutting edge width Saf of a cutting edge 42a larger than a tooth trace length gf of the left sub tooth flank 121a, and a blade thickness Taf (see FIG. 7) on a reference circle Cb of the cutting blade 42af smaller than a distance Hf (hereinafter, referred to as “tooth flank distance Hf”) between the left tapered tooth flank 121 and an opened end of the right tapered tooth flank 122 facing the left tapered tooth flank 121 when the cutting blade 42af cuts the left tapered tooth flank 121 by a length corresponding to a tooth trace length ff. At this time, the cutting edge width Saf of the cutting blade 42af and the blade thickness Taf on the reference circle Cb of the cutting blade 42af are set considering durability of the cutting blade 42af including, for example, damage and the like.

In the design of the cutting blade 42af, an intersection angle ϕf expressed by a difference between a torsion angle ϕf (hereinafter, referred to as “intersection angle ϕf of the first machining tool 42F”) of the left tapered tooth flank 121 and a torsion angle βf of the cutting blade 42af is required to be set as illustrated in FIG. 6B. As the torsion angle θf of the left tapered tooth flank 121 is a known value, and a possible range of setting of an intersection angle ϕf of the first machining tool 42F is set by the gear machining device 1, an operator provisionally sets the arbitrary intersection angle ϕf.

Subsequently, the torsion angle βf of the cutting blade 42af is obtained from the torsion angle θf of the known left tapered tooth flank 121 and the set intersection angle ϕf of the first machining tool 42F, and the cutting edge width Saf of the cutting blade 42af and the blade thickness Taf on a reference circle Cb of the cutting blade 42af are obtained. By repeating the above-described process described thus far, the first machining tool 42F having the optimal cutting blade 42af for cutting the left tapered tooth flank 121 is designed. An example of computation for obtaining the cutting edge width Saf of the cutting blade 42af and the blade thickness Taf on the reference circle Cb of the cutting blade 42af will be described below.

As illustrated in FIG. 7, the cutting edge width Saf of the cutting blade 42af is expressed by a cutting edge circle diameter da and a half angle ψaf of the blade thickness of the cutting edge circle (see Expression (1)).

Expression 1

Saf=ψaf·da (1)

The cutting edge circle diameter da is expressed by the reference circle diameter d and the addendum ha (see

Expression (2)), and in addition, the reference circle diameter d is expressed by the number of blades Z of the cutting blade 42af, a torsion angle βf of the blade traces 42bf of the cutting blade 42af and a module m (see Expression (3)), and the addendum ha is expressed by an addendum modification coefficient λ and the module m (see Expression (4).

Expression 2

da=d+2·ha (2)

Expression 3

d=Z·m/cos β f (3)

Expression 4

ha=2·m(1+λ) (4)

The half angle ψaf of the blade thickness of the cutting edge circle is expressed by the number of blades Z of the cutting blade 42af, and the addendum modification coefficient λ, the pressure angle α, a front pressure angle αt, and a cutting edge pressure angle αa (see Expression (5)). The front pressure angle αt is expressed by a pressure angle α and a torsion angle βf of the blade traces 42bf of the cutting blade 42af (see Expression (6)), and the cutting edge pressure angle αa is expressed by a front pressure angle αt, a cutting edge circle diameter da, and a reference circle diameter d (see Expression (7)).

Expression 5

ψ af=π/(2·Z)+2·λ·tan α/Z+(tan αt−α t)−(tan α a−α a) (5)

Expression 6

α t=tan⁻¹(tan α/cos β f) (6)

Expression 7

α a=cos⁻¹(d·cos α t/da) (7)

The blade thickness Taf of the cutting blade 42af is expressed by a half angle ψf of the blade thickness Taf and the reference circle diameter d (see Expression (8)).

Expression 8

Taf=ψ f·d (8)

The reference circle diameter d is expressed by the number of blades Z of the cutting blade 42af, the torsion angle βf of the blade traces 42bf of the cutting blade 42af and the module m (see Expression (9)).

Expression 9

d=Z·m/cos βf (9)

The half angle ψf of the blade thickness Taf is expressed by the number of blades Z of the cutting blade 42af, the addendum modification coefficient λ and the pressure angle α (see Expression (10)).

Expression 10

ψf=π/(2·Z)+2·λ·tan α/Z (10)

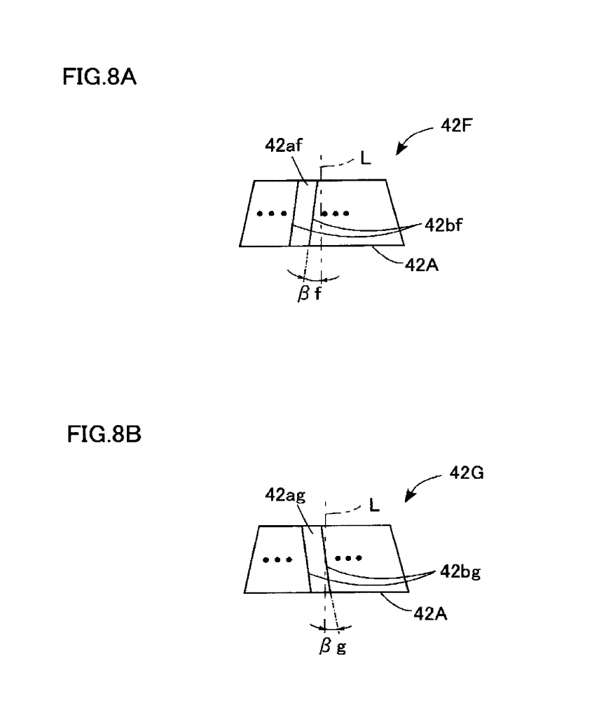

As described thus far, the first machining tool 42F is designed so that the blade traces 42bf of the cutting blade 42af have a torsion angle βf inclined from lower left to upper right when viewing the tool end surface 42A downward in the drawing from a direction perpendicular to the tool axis L as illustrated in FIG. 8A. In the same manner, as illustrated in FIG. 8B, the second machining tool 42G is designed so that the blade traces 42bg of the cutting blade 42ag have a torsion angle βg inclined from lower right to upper left when viewing the tool end surface 42A downward in the drawing from a direction perpendicular to the tool axis L.

When designing the second machining tool 42G, improvement of production efficiency is achieved by obtaining a torsion angle βg of the blade traces 42bg of the cutting blade 42ag with an angle which is the same as the intersection angle ϕf set for the first machining tool 42F as the intersection angle ϕg, because the setting of the machining state of the second machining tool 42G after the replacement of the first machining tool 42F with the second machining tool 42G does not have to be changed. The designs of the first machining tool 42F and the second machining tool 42G are to be performed by the tool design part 102 of the control apparatus 100, and detailed process will be described later.

### 3. Tool State of Machining Tool in Gear Machining Device

Machining accuracy achieved when the designed first machining tool 42F is applied to the gear machining device 1, and the left tapered tooth flanks 121 are cut while changing the tool state of the first machining tool 42F such as a position of the tool in the direction of the tool axis L of the first machining tool 42F (hereinafter, referred to as “axial position of the first machining tool 42F”) and the intersection angle ϕf of the first machining tool 42F will be studied below. The same applies to the machining accuracy achieved when cutting the right tapered tooth flank 122 with the second machining tool 42G, and thus detailed description will be omitted.

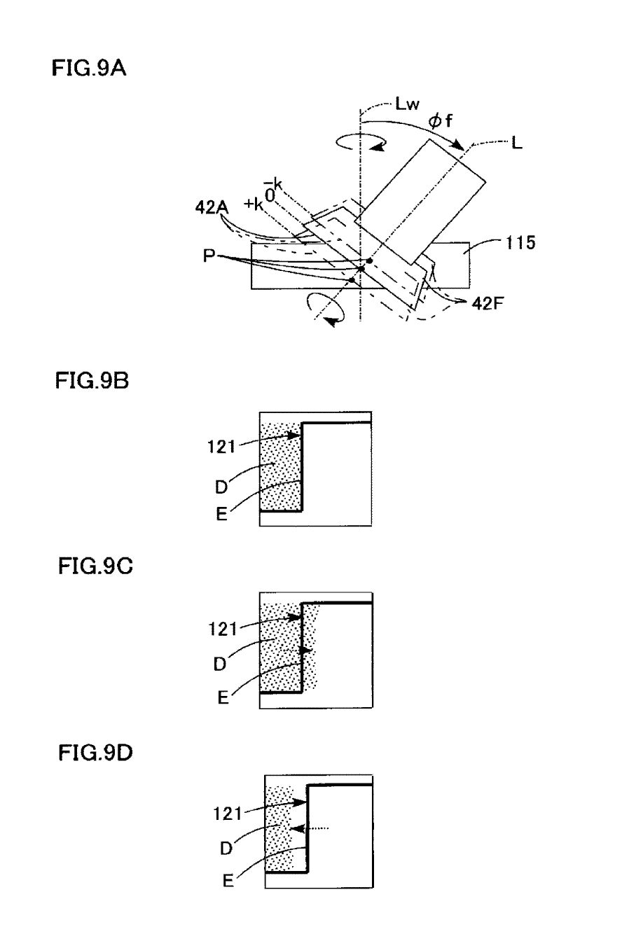

For example, as illustrated in FIG. 9A, the left tapered tooth flank 121 was machined in a state in which the axial position of the first machining tool 42F, that is, an intersection point P between the tool end surface 42A and the tool axis L of the first machining tool 42F was located on a rotation axis Lw of the sleeve 115 (amount of offset: 0), in a state in which the intersection point P was offset by a distance +k in the direction of the tool axis L of the first machining tool 42F (amount of offset: +k), and in a state in which the intersection point P was offset by a distance −k in the direction of the tool axis L of the first machining tool 42F (the amount of offset: −k). The intersection angle ϕf of the first machining tool 42F was the same for all the cases.

Resulted machining states of the left tapered tooth flank 121 were as illustrated in FIG. 9B, FIG. 9C, and FIG. 9D. Thick solid lines E in the drawing are involute curves of the left tapered tooth flank 121 in design converted into straight lines and dot potions D indicate cut and removed portions.

As illustrated in FIG. 9B, with an amount of offset of 0, the machined left tapered tooth flank 121 has a shape similar to the involute curve in design. In contrast, with an amount of offset +k as illustrated in FIG. 9C, the machined left tapered tooth flank 121 has a shape shifted rightward (in the direction of a dotted arrow) in the drawing, that is, shifted in a direction of a clockwise pitch circle with respect to the involute curve in design, and with an amount of offset −k as illustrated in FIG. 9D, the machined left tapered tooth flank 121 has a shape shifted leftward (in the direction of a dotted arrow) in the drawing, that is, shifted in a direction of a counter-clockwise pitch circle with respect to the involute curve in design. Therefore, the shape of the left tapered tooth flank 121 may be shifted in the direction of the pitch circle by changing the position of the machining tool 42 in the direction of the tool axis L.

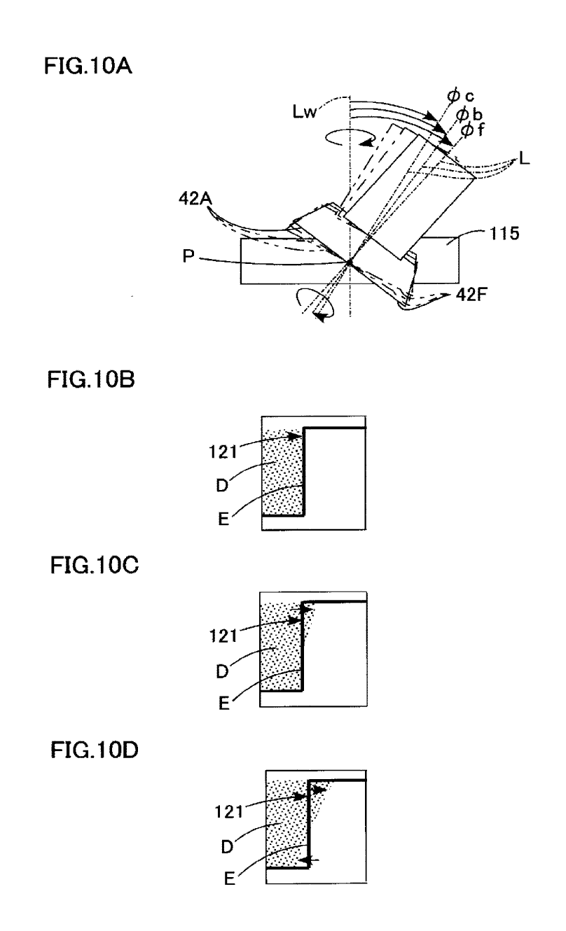

In addition, for example, as illustrated in FIG. 10A, the left tapered tooth flank 121 was machined in each case where the intersection angle of the first machining tool 42F is ϕf, ϕg, and ϕc. The relationship of these angles in magnitude is ϕf>ϕb>ϕc. Consequently, the machining states of the left tapered tooth flank 121 were as illustrated in FIG. 10B, FIG. 10C, and FIG. 10D.

As illustrated in FIG. 10B, with the intersection angle ϕf, the machined left tapered tooth flank 121 has a shape similar to the involute curve in design. In contrast, with an intersection angle ϕb as illustrated in FIG. 10C, the machined left tapered tooth flank 121 has a shape narrowed in width of the tooth tip in a direction of the pitch circle (in the direction of a solid arrow) and widened in width of the tooth root in the direction of the pitch circle (in the direction of the solid arrow) with respect to the involute curve in design, and with an intersection angle ϕc as illustrated in FIG. 10D, the machined left tapered tooth flank 121 has a shape further narrowed in width of the tooth tip in a direction of the pitch circle (in the direction of the solid arrow) and further widened in width of the tooth root in the direction of the pitch circle (in the direction of the solid arrow) with respect to the involute curve in design. Therefore, the shape of the left tapered tooth flank 121 may be changed in width of the tooth tip in the direction of the pitch circle and in width of the tooth root in the direction of the pitch circle by changing the intersection angle of the first machining tool 42F.

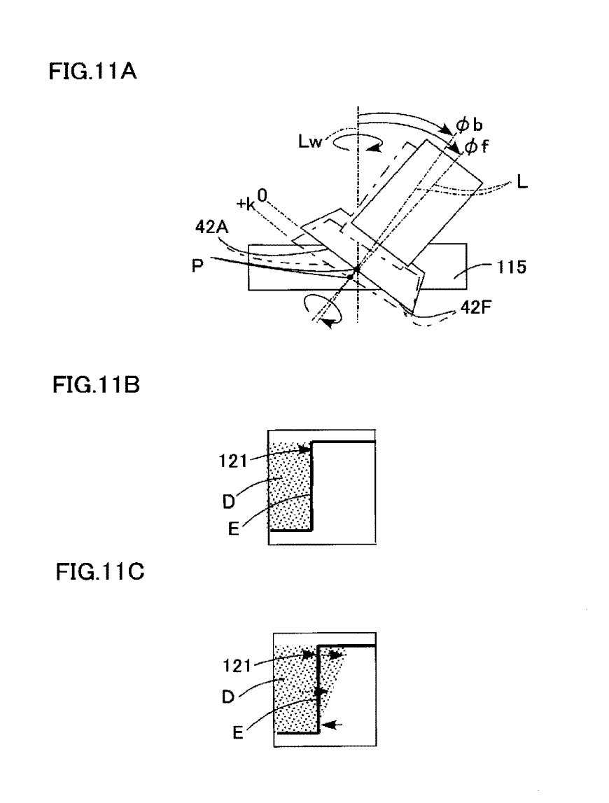

For example, as illustrated in FIG. 11A, the left tapered tooth flank 121 was machined in a state in which the axial position of the first machining tool 42F, that is, the intersection point P between the tool end surface 42A and the tool axis L of the first machining tool 42F was located on the rotation axis Lw of the sleeve 115 (amount of offset: 0) and the intersection angle of the first machining tool 42F was ϕf, and in a state in which the intersection point P was offset by a distance +k in the direction of the tool axis L of the first machining tool 42F (amount of offset: +k) and the intersection angle was ϕb. Consequently, the machining states of the left tapered tooth flank 121 were as illustrated in FIG. 11B and FIG. 11C.

As illustrated in FIG. 11B, with the amount of offset 0 and the intersection angle ϕf, the machined left tapered tooth flank 121 has a shape similar to the involute curve in design. In contrast, as illustrated in FIG. 11C, with the amount of offset +k and the intersection angle ϕb, the machined left tapered tooth flank 121 is shifted rightward in the drawing (in the direction of a dotted arrow), that is, shifted in the clockwise direction of the pitch circle, and has a tooth tip narrowed in width in the direction of the pitch circle (direction of a solid arrow) and a tooth root widened in the direction of the pitch circle (in the direction of a solid arrow) with respect to the involute curve in design. Therefore, the shape of the left tapered tooth flank 121 may be shifted in the direction of the pitch circle by changing the axial position of the machining tool 42 and the intersection angle of the first machining tool 42F, so as to allow the width of the tooth tip in the circumferential direction and the width of the tooth root in the direction of the pitch circle to be changed.

As described thus far, the first machining tool 42F is capable of cutting the left tapered tooth flanks 121 with high degree of accuracy by setting with the amount of offset to 0 and the intersection angle to ϕf in the gear machining device 1. The tool states of the first machining tool 42F and the second machining tool 42G may be set by the tool state computing part 103 of the control apparatus 100, and detailed description of the process will be described later.

### 4. Process to be Performed by Tool Design Part of Control Apparatus

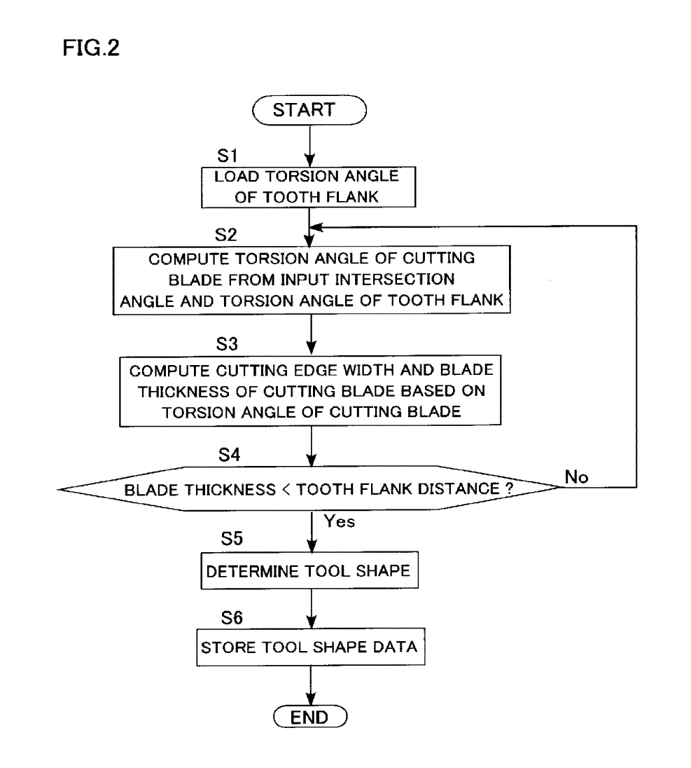

Referring now to FIG. 2, FIG. 6A, and FIG. 6B, designing process to be performed on the first machining tool 42F by the tool design part 102 of the control apparatus 100 will be described. Data relating to the gear coming-off preventing portions 120, that is, the torsion angle θf and the tooth trace length ff of the left tapered tooth flank 121 and the tooth trace length gf and the tooth flank distance Hf of the left sub tooth flank 121a are assumed to be stored in the memory 104 in advance. In addition, data relating to the first machining tool 42F such as the number of blades Z, the cutting edge circle diameter da, the reference circle diameter d, the addendum ha, the module m, the addendum modification coefficient λ, the pressure angle α, the front pressure angle αt, and the cutting edge pressure angle αa are assumed to be stored in the memory 104 in advance.

The tool design part 102 of the control apparatus 100 loads the torsion angle θf of the left tapered tooth flank 121 from the memory 104 (Step S1 in FIG. 2). Then, the tool design part 102 obtains a difference between the intersection angle ϕf of the first machining tool 42F input by an operator and a torsion angle θf of the loaded left tapered tooth flank 121 as a torsion angle βf of the blade traces 42bf of the cutting blade 42af of the first machining tool 42F (Step S2 in FIG. 2).

The tool design part 102 loads the number of blades Z or the like of the first machining tool 42F from the memory 104 and obtains the cutting edge width Saf and the blade thickness Taf of the cutting blade 42af based on the loaded number of blades Z or the like of the loaded first machining tool 42F and the obtained torsion angle βf of the blade traces 42bf of the cutting blade 42af. The cutting edge width Saf of the cutting blade 42af is obtained from the involute curve based on the blade thickness Taf. If a desirable engagement can be maintained at the teeth portion, the cutting edge width Saf is obtained as a non-involute or linear tooth flank (Step S3 in FIG. 2).

The tool design part 102 reads out the tooth flank distance Hf from the memory 104, and determines whether or not the obtained blade thickness Taf of the tool cutting blade 42af is smaller than the tooth flank distance Hf (Step S4 in FIG. 2). When the obtained blade thickness Taf of the cutting blade 42af is equal to or larger than the tooth flank distance Hf, the tool design part 102 returns back to Step S2 and repeats the above-described process.

In contrast, when the obtained blade thickness Taf of the cutting blade 42af is reduced to a thickness smaller than the tooth flank distance Hf, the tool design part 102 determines the shape of the machining tool 42 based on the obtained torsion angle βf of the blade traces 42bf of the cutting blade 42af (Step S5 in FIG. 2), and stores the determined shape data of the first machining tool 42F in the memory 104 (Step S6 in FIG. 2), and ends the entire process. Accordingly, the first machining tool 42F having the optimum cutting blade 42af is designed.

### 5. Process to be Performed by Tool State Computing Part of Control Apparatus

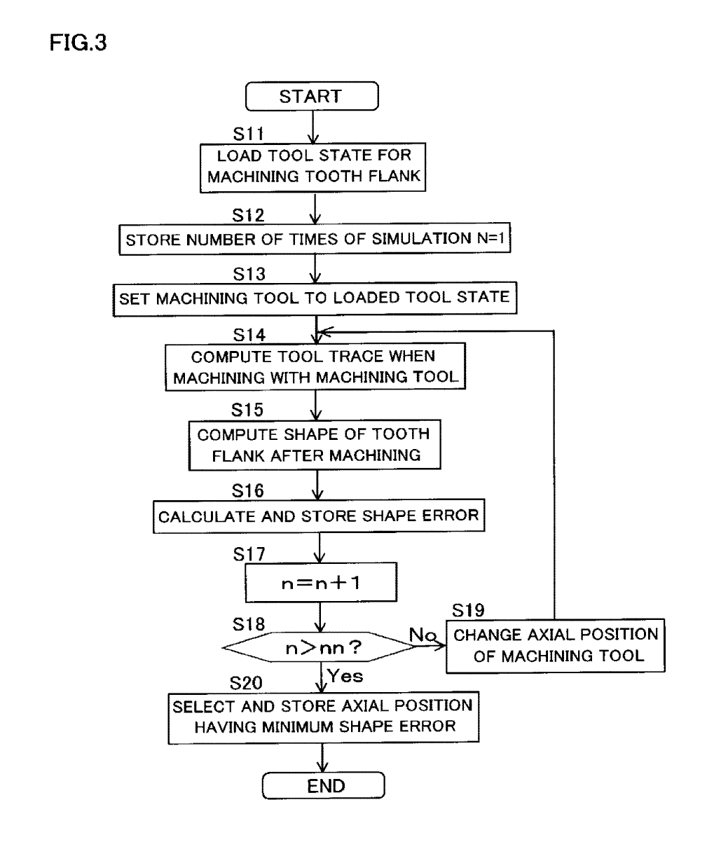

Referring now to FIG. 3, the process to be performed by the tool state computing part 103 of the control apparatus 100 will be described. As this process is a simulation process for computing a trajectory of the cutting blade 42af of the first machining tool 42F based on a known gear creation theory, an actual machining is not necessary, and thus cost reduction may be achieved.

The tool state computing part 103 of the control apparatus 100 loads a tool state such as the axial position of the first machining tool 42F or the like for cutting the left tapered tooth flank 121 from the memory 104 (Step S11 in FIG. 3), stores “1 (first time)” as the number of times of simulation n in the memory 104 (Step S12 in FIG. 3), and sets the first machining tool 42F to the loaded tool state (Step S13 in FIG. 3).

The tool state computing part 103 obtains a tool trajectory to be taken for machining the left tapered tooth flank 121 based on the shape data of the first machining tool 42F loaded from the memory 104 (Step S14 in FIG. 3), and obtains the shape of the left tapered tooth flank 121 after machining (Step S15 in FIG. 3). Then, the tool state computing part 103 compares the obtained shape of the left tapered tooth flank 121 after the machining and the shape of the left tapered tooth flank 121 in design, obtains a shape error and stores the obtained shape error in the memory 104 (Step S16 in FIG. 3), and increments the number of times of simulation n by 1 (Step S17 in FIG. 3).

The tool state computing part 103 determines whether or the not the number of times of simulation n reaches a predetermined number of times nn (Step S18 in FIG. 3), and if the number of times of simulation n does not reach the preset number of times nn, changes the tool state of the first machining tool 42F, for example, the axial position of the first machining tool 42F (Step S19 in FIG. 3), then goes back to Step S14 and repeats the above-described process. In contrast, when the number of times of simulation n reaches the preset number of times nn, the tool state computing part 103 selects the axial position of the first machining tool 42F which has the minimum error out of the stored shape errors and stores the selected axial position in the memory 104 (Step S20 in FIG. 3), and ends the entire process.

In the above-described process, the simulation is performed by a plurality of number of times and the axial position of the first machining tool 42F that has the minimum error is selected. However, it is also possible to set an allowable shape error in advance, and select the axial position of the first machining tool 42F when the shape error calculated in Step S16 becomes a value equal to or smaller than the allowable shape error. In the Step S19, instead of changing the axial position of the first machining tool 42F, it is also possible to change the intersection angle θf of the first machining tool 42F or change the position of the first machining tool 42F about the axis, or change an arbitrary combination of the intersection angle, the axial position, and the position about the axis.

### 6. Process to be Performed by Machining Control Part of Control Apparatus

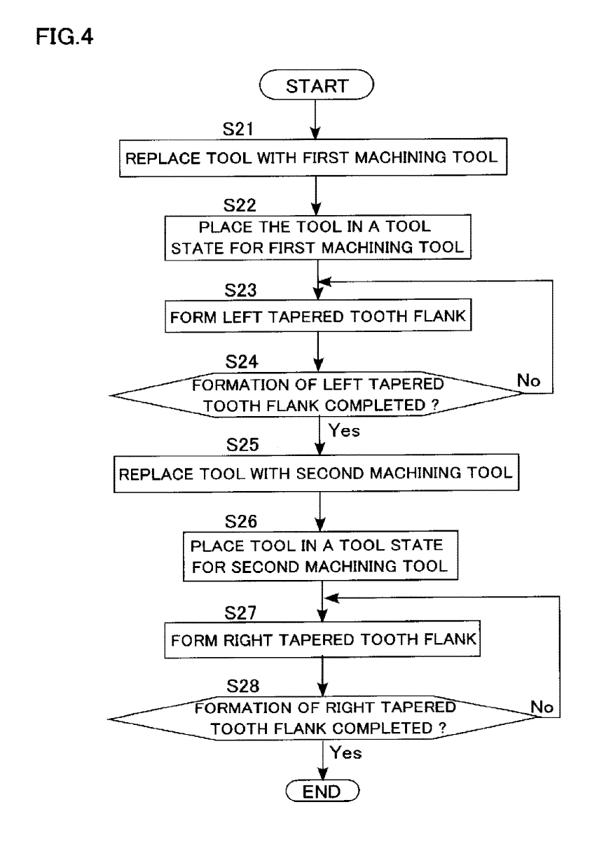

Referring now to FIG. 4, the process to be performed by the machining control part 101 of the control apparatus 100 will be described. It is assumed here that an operator manufactures the first machining tool 42F and the second machining tool 42G based on the respective shape data of the first machining tool 42F and the second machining tool 42G designed by the tool design part 102, and sets them in an automatic tool replacement device in the gear machining device 1. It is also assumed that the sleeve 115 is mounted on the workpiece holder 80 of the gear machining device 1, and the inner teeth 115a are formed by turning, broaching, or the like.

The machining control part 101 of the control apparatus 100 replaces the machining tool of the previous machining step (turning or broaching, etc.) with the first machining tool 42F by means of the automatic tool replacement device (Step S21 in FIG. 4). The machining control part 101 places the first machining tool 42F and the sleeve 115 so as to achieve the tool state of the first machining tool 42F obtained by the tool state computing part 103 (Step S22 in FIG. 4), cuts the inner teeth 115a by feeding the first machining tool 42F in the direction of the rotation axis Lw of the sleeve 115 while rotating the first machining tool 42F synchronously with the sleeve 115 and forms the left tapered tooth flanks 121 including the left sub tooth flanks 121a on the inner teeth 115a, respectively (Step S23 in FIG. 4).

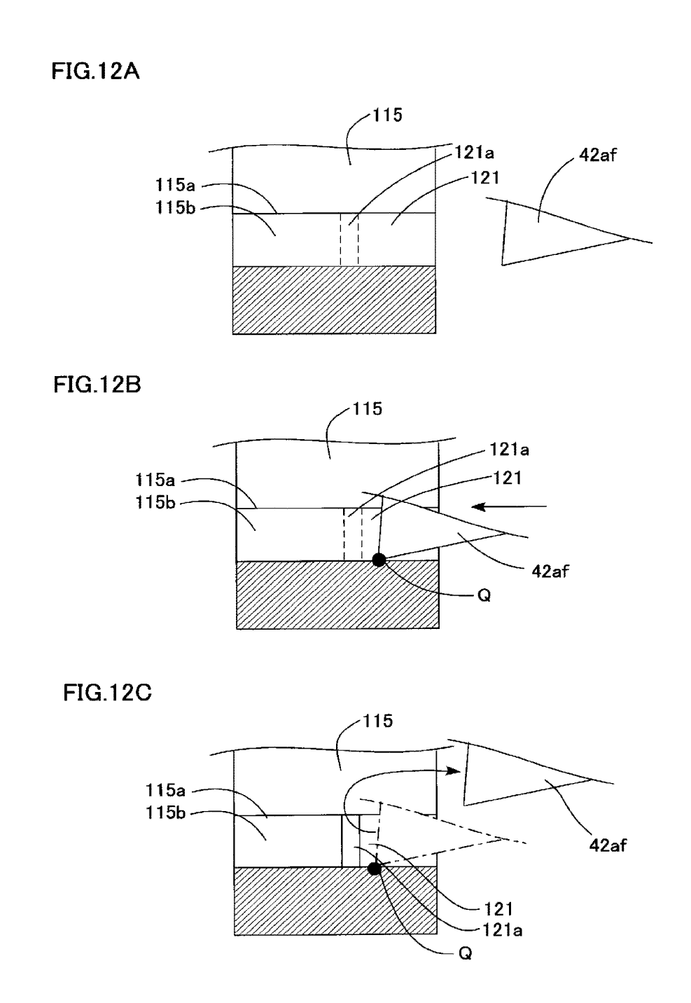

In other words, as illustrated in FIG. 12A to FIG. 12C, the first machining tool 42F forms the left tapered tooth flanks 121 including the left sub tooth flanks 121a on the inner teeth 115a by one or more times of cutting operation in the direction of the rotation axis Lw of the sleeve 115. The first machining tool 42F at this time needs to perform a feeding operation and a returning operation in the opposite direction from the feeding operation. However, as illustrated in FIG. 12C, the reversing operation is associated with an inertial force. Therefore, the feeding operation of the first machining tool 42F ends at a point Q, which is shorter by a predetermined amount than the tooth trace length ff of the left tapered tooth flanks 121 which can form the left tapered tooth flanks 121 including the left sub tooth flanks 121a, and is transferred to the returning operation. The feed end point Q may be obtained by measuring with a sensor or the like. However, if the feeding amount is sufficiently accurate with respect to the required machining accuracy, measurement is not necessary and point Q may be adjusted by the feeding amount. In other words, accurate machining is achieved by a cutting work while adjusting the feeding amount so as to ensure machining up to the point Q.

When cutting of the left tapered tooth flanks 121 is completed (Step S24 in FIG. 4), the machining control part 101 causes the automatic tool replacement device to replace the first machining tool 42F with the second machining tool 42G (Step S25 in FIG. 4). The machining control part 101 places the second machining tool 42G and the sleeve 115 so as to achieve the tool state of the second machining tool 42G obtained by the tool state computing part 103 (Step S26 in FIG. 4), cuts the inner teeth 115a by feeding the second machining tool 42G in the direction of the rotation axis Lw of the sleeve 115 while rotating the second machining tool 42G synchronously with the sleeve 115 and forms the right tapered tooth flanks 122 including the right sub tooth flanks 122a on the inner teeth 115a respectively (Step S27 in FIG. 4). When cutting of the right tapered tooth flanks 122 is completed (Step S28 in FIG. 4), the machining control part 101 ends the entire process.

### 7. Modification of Machining Tool

In the above-described example, the case of cutting the left tapered tooth flanks 121 and the right tapered tooth flanks 122 which constitute the gear coming-off preventing portions 120 of the sleeve 115 respectively by using two machining tools 42 (the first machining tool 42F and the second machining tool 42G) has been described. In this example, a case of cutting by using the single machining tool 42 will be described.

Examples of methods to be taken for cutting the left tapered tooth flanks 121 and the right tapered tooth flanks 122 at different torsion angles with the single machining tool 42 include a method of using a machining tool 42 including cutting blades 42a having a right blade surface and a left blade surface at different torsion angles, and a method of using the machining tool 42 including cutting blades 42a having a left blade surface and a right blade surface at the same torsion angle. In this example, a case of cutting by using the machining tool 42 including the cutting blades 42a having the left blade surface and the right blade surface at the same torsion angle will be described. In this case, the intersection angle ϕf of the machining tool 42 when cutting the left tapered tooth flank 121 and the intersection angle ϕr of the machining tool 42 when cutting the right tapered tooth flank 122 need to be differentiated.

In the case of the machining tool 42 as well, in the same manner as the first machining tool 42F and the second machining tool 42G, the cutting blade 42af of the machining tool 42 needs to have a shape which definitely allows the left tapered tooth flanks 121 including the left sub tooth flanks 121a and the right tapered tooth flank 122 including the right sub tooth flank 122a to be cut without interference with the adjacent inner teeth 115a while cutting the inner teeth 115a. Therefore, designing of the machining tool 42 is performed by the tool design part 102 of the control apparatus 100.

The machining tool 42 needs to have ability to cut the left tapered tooth flank 121 including the left sub tooth flank 121a and the right tapered tooth flank 122 including the right sub tooth flank 122a with high degree of accuracy. Therefore, setting of the tool state of the machining tool 42 is performed by the tool state computing part 103 of the control apparatus 100. The cutting work by the machining tool 42 is performed by the machining control part 101. In the following description, the process to be performed by the tool state computing part 103 is the same as the example described above, and the process performed by the machining control part 101 is the same as the example described above except for the point that replacement of the tool is not performed, an thus detailed description will be omitted and the process to be performed by the tool design part 102 will be described.

### 8. Process to be Performed by Tool Design Part of Control Apparatus

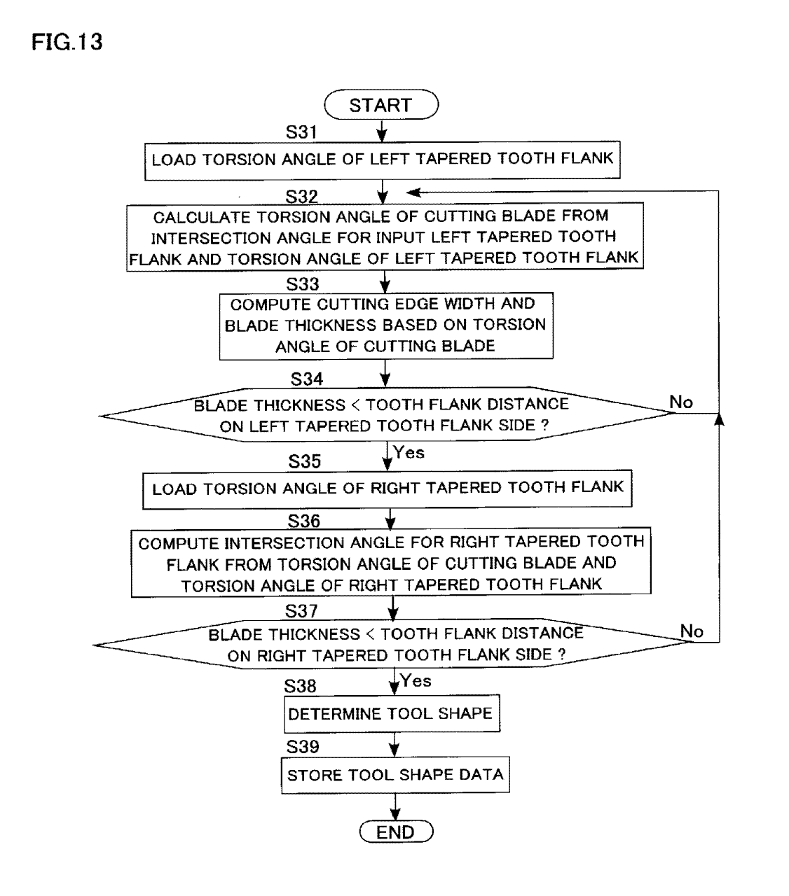

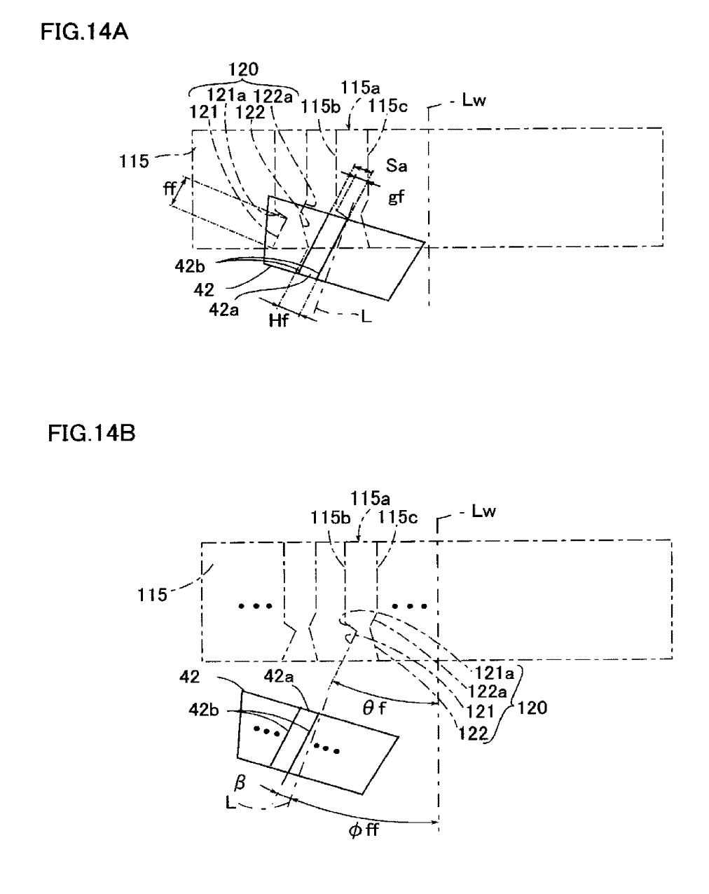

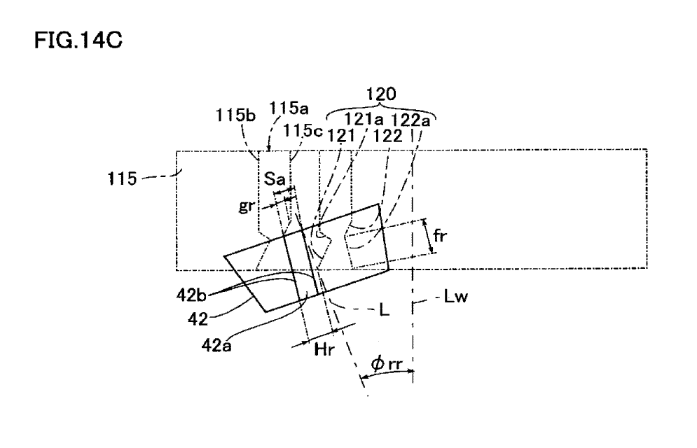

Subsequently, designing process to be performed by the tool design part 102 of the control apparatus 100 on the machining tool 42 will be described with reference to FIG. 13, FIG. 14A, FIG. 14B, and FIG. 14C. Note that data relating to the gear coming-off preventing portions 120, that is, the torsion angle θf and the tooth trace length ff of the left tapered tooth flank 121, the tooth trace length gf and the tooth flank distance Hf of the left sub tooth flank 121a, the torsion angle θr and the tooth trace length fr of the right tapered tooth flank 122, and the tooth trace length gr and the tooth flank distance Hr of the right sub tooth flank 122a are assumed to be stored in the memory 104 in advance. In addition, data relating to the machining tool 42 such as the number of blades Z, the cutting edge circle diameter da, the reference circle diameter d, the addendum ha, the module m, the addendum modification coefficient λ, the pressure angle α, the front pressure angle αt, and the cutting edge pressure angle αa are assumed to be stored in the memory 104 in advance.

The tool design part 102 of the control apparatus 100 loads the torsion angle θf of the left tapered tooth flank 121 from the memory 104 (Step S31 in FIG. 13). Then, the tool design part 102 obtains a difference between the intersection angle ϕff of the machining tool 42 input by an operator when cutting the left tapered tooth flank 121 and a torsion angle θff of the loaded left tapered tooth flank 121 as a torsion angle β of the blade traces 42b of the cutting blade 42a of the machining tool 42 (Step S32 in FIG. 13).

The tool design part 102 loads the number of blades Z or the like of the machining tool 42 from the memory 104 and obtains the cutting edge width Sa and the blade thickness Ta of the cutting blade 42a based on the loaded number of blades Z or the like of the loaded machining tool 42 and the obtained torsion angle β of the blade traces 42b of the cutting blade 42a. The cutting edge width Sa of the cutting blade 42a is obtained from the involute curve based on the blade thickness Ta. If a desirable engagement can be maintained at the teeth portion, the cutting edge width Sa is obtained as a non-involute or linear tooth flank (Step S33 in FIG. 13).

The tool design part 102 reads out the tooth flank distance Hf from the memory 104, and determines whether or not the obtained blade thickness Ta of the tool cutting blade 42a is smaller than the tooth flank distance Hf on the left tapered tooth flank 121 side (Step S34 in FIG. 13). When the obtained blade thickness Ta of the cutting blade 42a is equal to or larger than the tooth flank distance Hf on the left tapered tooth flank 121 side, the tool design part 102 returns back to Step S32 and repeats the above-described process.

In contrast, the tool design part 102 loads the torsion angle θr of the right tapered tooth flank 122 from the memory 104 when the blade thickness Ta of the obtained cutting blade 42a becomes smaller than the tooth flank distance Hf on the left tapered tooth flank 121 side (Step S35 in FIG. 13). The tool design part 102 then obtains a difference between the torsion angle β (βT) of the blade traces 42b of the cutting blade 42a of the machining tool 42 obtained in Step S32 and the loaded torsion angle θr of the right tapered tooth flank 122 as an intersection angle ϕrr of the machining tool 42 when cutting the right tapered tooth flank 122 (Step S36 of FIG. 13).

The tool design part 102 reads out the tooth flank distance Hr from the memory 104, and whether or not the blade thickness Ta is smaller than the tooth flank distance Hr on the right tapered tooth flank 122 side is determined (Step S37 in FIG. 13). When the blade thickness Ta is equal to or larger than the tooth flank distance Hr on the right tapered tooth flank 122 side, the tool design part 102 returns back to Step S32 and repeats the above-described process.

In contrast, when the blade thickness Ta is reduced to a thickness smaller than the tooth flank distance Hr on the right tapered tooth flank 122 side, the tool design part 102 determines the shape of the machining tool 42 based on the obtained torsion angle β of the blade traces 42b of the cutting blade 42a (Step S38 in FIG. 13), stores the determined shape data of the machining tool 42 in the memory 104 (Step S39 in FIG. 13), and ends the entire process. Accordingly, the machining tool 42 having the optimum cutting blade 42a is designed.

### 9. Machining Tool for Processing First Alternative Shape

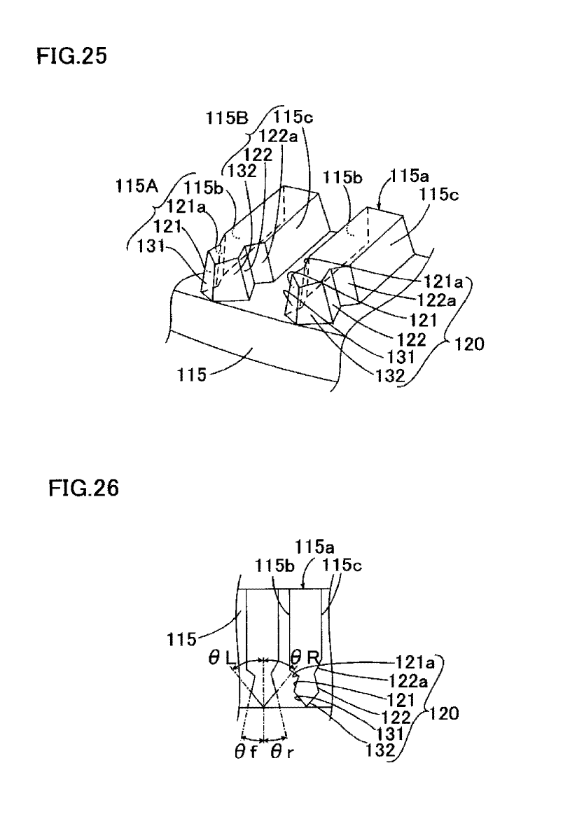

As described above, the gear coming-off preventing portions 120 which are engageable with the outer teeth 117a of the clutch gear 117 and the outer teeth 118a of the synchronizer ring 118 are formed on the inner teeth 115a of the sleeve 115. Examples of alternative shapes of the gear coming-off preventing portions 120 include gear coming-off preventing portions 120 formed on the inner teeth 115a of the sleeve 115, each including a left chamfered (beveled) tooth flank 131 and a right chamfered (beveled) tooth flank 132 formed at ends on the left tapered tooth flank 121 side and the right tapered tooth flank 122 sides for smooth engagement as illustrated in FIG. 25 and FIG. 26.

In other words, the left side surface 115A of the inner tooth 115a of the sleeve 115 includes a left tooth flank 115b, a left tapered tooth flank 121, and a left chamfered tooth flank 131 having a torsion angle different from the left tooth flank 115b (which corresponds to “second tooth flank” of the invention). Also, the right side surface 115B of the inner tooth 115a of the sleeve 115 includes a right tooth flank 115c, a right tapered tooth flank 122, and a right chamfered tooth flank 132 at a different torsion angle from the right tooth flank 115c (which corresponds to “fourth tooth flank” or “second tooth flank” of the invention). In this example, the torsion angle of the left chamfered tooth flank 131 is θL degree and the torsion angle of the right chamfered tooth flank 132 is θR.

In this example, a case where the left chamfered tooth flank 131 and the right chamfered tooth flank 132 are formed respectively by cutting with two of the machining tools 42 will be described. In the following description, a case of designing the machining tool 42 for cutting the right chamfered tooth flank 132 (hereinafter, referred to as “second machining tool 42R”) will be described. However, as the same applies to a case of designing the machining tool 42 for cutting the left chamfered tooth flank 131 (hereinafter, referred to as “first machining tool 42L”), detailed description will be omitted.

The second machining tool 42R is formed into substantially the same shape as the shape of the second machining tool 42G for cutting the left tapered tooth flank 121 (see FIG. 5A, FIG. 5B, and FIG. 5C, provided that suffixes f, F are replaced by g, G) except for the shape of the cutting blade 42ag of the second machining tool 42G (the shape of the involute curve). In other words, the shape of a cutting blade 42aR of the second machining tool 42R (see FIG. 18) has a pressure angle of the right chamfered tooth flank 132 of substantially 0 degree, and thus is formed into substantially rectangular shape in this example.

The right chamfered tooth flanks 132 of the sleeve 115 are formed by cutting the inner teeth 115a of the sleeve 115, which are already formed, with the second machining tool 42R. Therefore, the cutting blade 42aR of the second machining tool 42R needs to have a shape which allows the right chamfered tooth flank 132 to be cut without interference with the adjacent inner teeth 115a while cutting the inner teeth 115a.

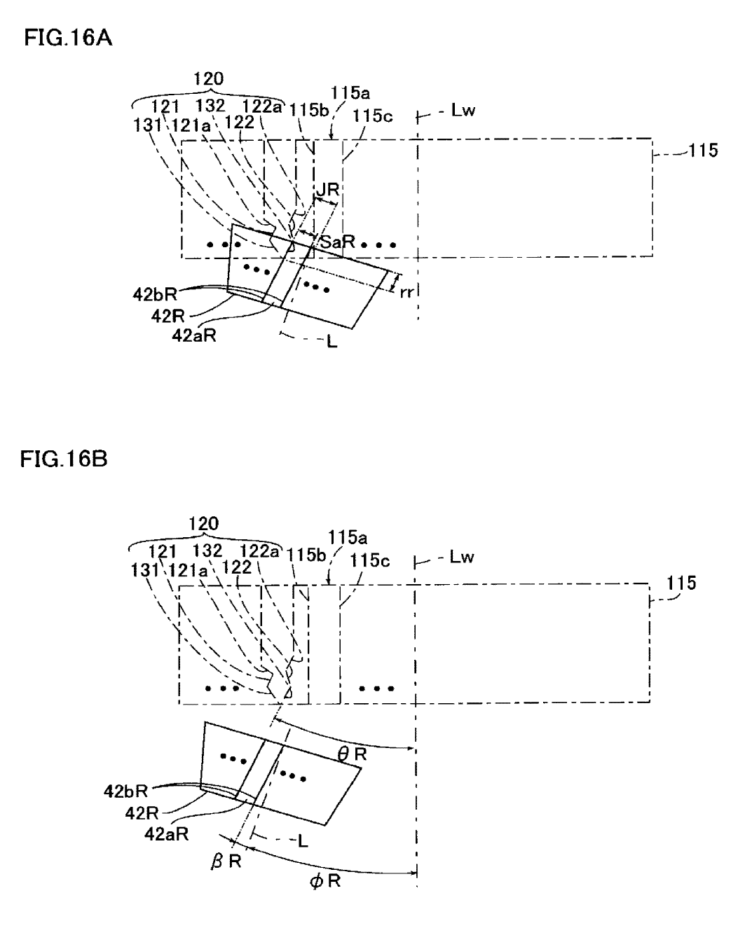

Specifically, as illustrated in FIG. 16A, the cutting blade 42aR is required to be designed so as to make a cutting edge width SaR of the cutting blade 42aR smaller than a distance JR between the right chamfered tooth flank 132 and the left tooth flank 115b of the inner tooth 115a facing the right chamfered tooth flank 132 (hereinafter referred to as “tooth flank distance JR”) when the cutting blade 42aR cuts the right chamfered tooth flank 132 by a length corresponding to a tooth trace length rr. At this time, the cutting edge width SaR of the cutting blade 42aR is set considering durability of the cutting blade 42aR including, for example, damage and the like.

In the design of the cutting blade 42aR, an intersection angle ϕR expressed by a difference between a torsion angle σr of the right chamfered tooth flank 132 and a torsion angle βR of the cutting blade 42aR (hereinafter, referred to as “intersection angle ϕR of the second machining tool 42R”) is required to be set as illustrated in FIG. 16B. As the torsion angle σr of the right chamfered tooth flank 132 is a known value, and a possible range of setting of the intersection angle ϕR of the second machining tool 42R is set by the gear machining device 1, an operator provisionally sets the arbitrary intersection angle ϕR.

Subsequently, the torsion angle βR of the cutting blade 42aR is obtained from the known torsion angle σr of the right chamfered tooth flank 132 and the set intersection angle ϕR of the second machining tool 42R, and then the cutting edge width SaR of the cutting blade 42aR is obtained. By repeating the above-described process described thus far, the second machining tool 42R having the optimal cutting blade 42aR for cutting the right chamfered tooth flanks 132 is designed.

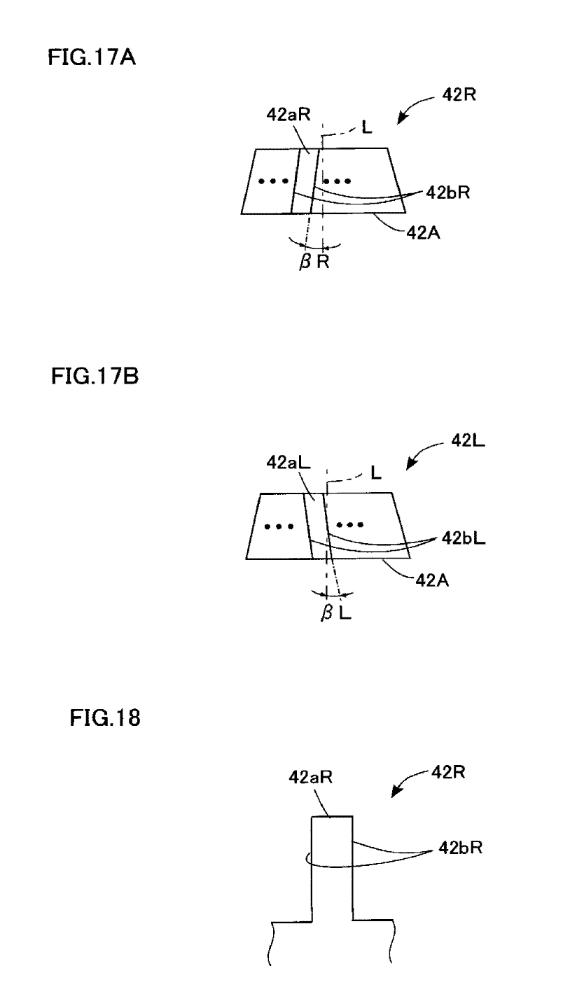

As described thus far, the second machining tool 42R is designed so that the blade traces 42bR of the cutting blade 42aR have the torsion angle βR inclined from lower left to upper right when viewing the tool end surface 42A downward in the drawing from a direction perpendicular to the tool axis L as illustrated in FIG. 17A. In the same manner, as illustrated in FIG. 17B, the first machining tool 42L is designed so that the blade traces 42bL of the cutting blade 42aL have a torsion angle βL inclined from lower right to upper left when viewing the tool end surface 42A downward in the drawing from a direction perpendicular to the tool axis L.

When designing the first machining tool 42L, improvement of production efficiency is achieved by obtaining the torsion angle βL of the blade traces 42bL of the cutting blade 42aL with an angle which is the same angle as the intersection angle ϕL set for the second machining tool 42R as the intersection angle ϕR, because the setting of the machining state of the first machining tool 42L after the replacement of the first machining tool 42L with the second machining tool 42R does not have to be changed. The designs of the first machining tool 42L and the second machining tool 42R are to be performed by the tool design part 102 of the control apparatus 100.

The first machining tool 42L and the second machining tool 42R need to be capable of cutting the left chamfered tooth flank 131 and the right chamfered tooth flank 132 with high degree of accuracy. Therefore, setting of the tool states of the first machining tool 42L and the second machining tool 42R is performed by the tool state computing part 103 of the control apparatus 100. The cutting work by the first machining tool 42L and the second machining tool 42R is performed by the machining control part 101. As the process to be performed by the tool state computing part 103 and the process to be performed by the machining control part 101 are the same as the example described above, detailed description is omitted and the process to be performed by the tool design part 102 will be described in the following description.

### 10. Process to be Performed by Tool Design Part of Control Apparatus

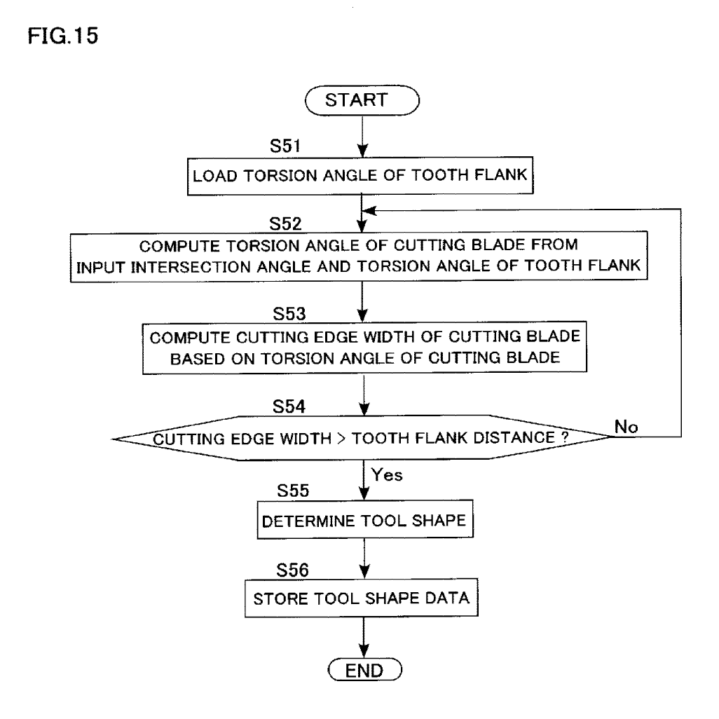

A process of designing the second machining tool 42R to be performed by the tool design part 102 of the control apparatus 100 will be described with reference to FIG. 15, FIG. 16A, and FIG. 16B. The torsion angle θr, the tooth trace length rr, the height, the pressure angle, and the tooth flank distance JR of the right chamfered tooth flank 132 are assumed to be stored in the memory 104 in advance. In addition, data relating to the second machining tool 42R such as the number of blades Z, the cutting edge circle diameter da, the reference circle diameter d, the addendum ha, the module m, the addendum modification coefficient λ, the pressure angle α, the front pressure angle αt, and the cutting edge pressure angle αa are assumed to be stored in the memory 104 in advance.

The tool design part 102 of the control apparatus 100 loads the torsion angle θr of the right chamfered tooth flank 132 from the memory 104 (Step S51 in FIG. 15). Then, the tool design part 102 obtains a difference between the intersection angle ϕR of the second machining tool 42R input by the operator and the loaded torsion angle θr of the right chamfered tooth flank 132 as a torsion angle βR of the blade traces 42bR of the cutting blade 42aR of the second machining tool 42R (Step S52 in FIG. 15).

The tool design part 102 loads the number of blades Z or the like of the second machining tool 42R from the memory 104 and obtains the cutting edge width SaR of the cutting blade 42aR based on the number of blades Z or the like of the loaded second machining tool 42R and the obtained torsion angle βR of the blade traces 42bR of the cutting blade 42aR (Step 53 in FIG. 15). The tool design part 102 reads out the tooth flank distance JR from the memory 104, and determines whether or not the obtained cutting edge width SaR of the cutting blade 42aR is smaller than the tooth flank distance JR (Step S54 in FIG. 15).

When the obtained cutting edge width SaR of the cutting blade 42aR is equal to or larger than the tooth flank distance JR, the tool design part 102 returns back to Step S52 and repeats the above-described process. In contrast, when the obtained cutting edge width SaR of the cutting blade 42aR is reduced to a distance smaller than the tooth flank distance JR, the tool design part 102 determines the shape of the second machining tool 42R based on the obtained torsion angle βR of the blade traces 42bR of the cutting blade 42aR (Step S55 in FIG. 15), stores the determined shape data of the second machining tool 42R in the memory 104 (Step S56 in FIG. 15), and ends the entire process. Accordingly, the second machining tool 42R having the optimum cutting blade 42aR is designed. The same applied to the designing process for the first machining tool 42L.

### 11. Another Mode of Machining Tool for Machining First Alternative Shape

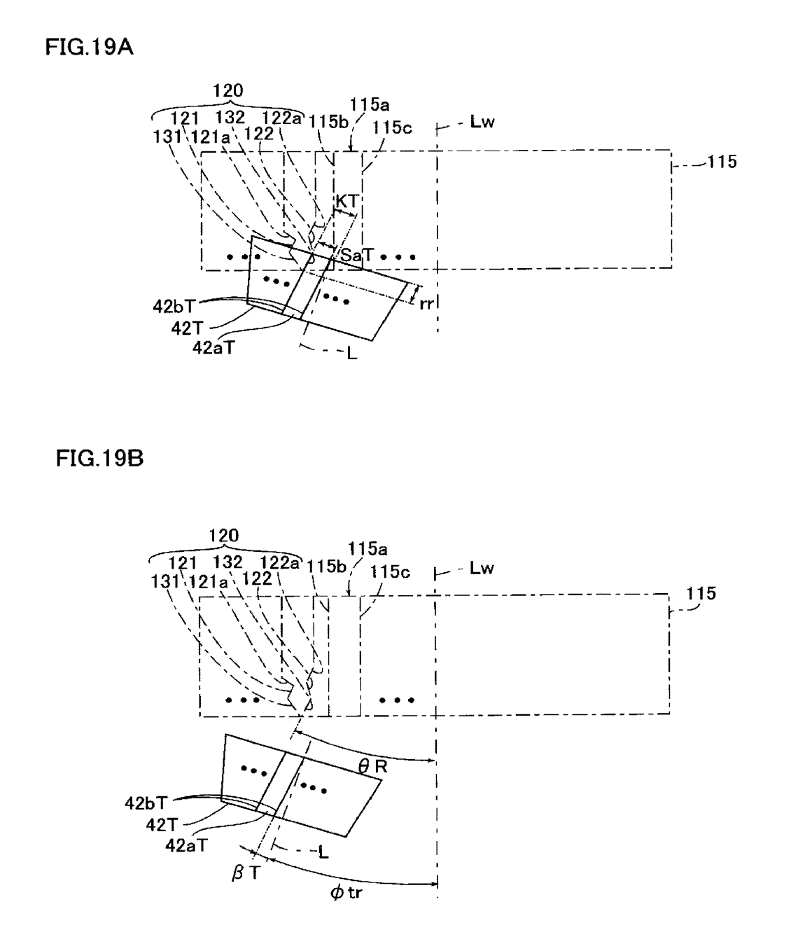

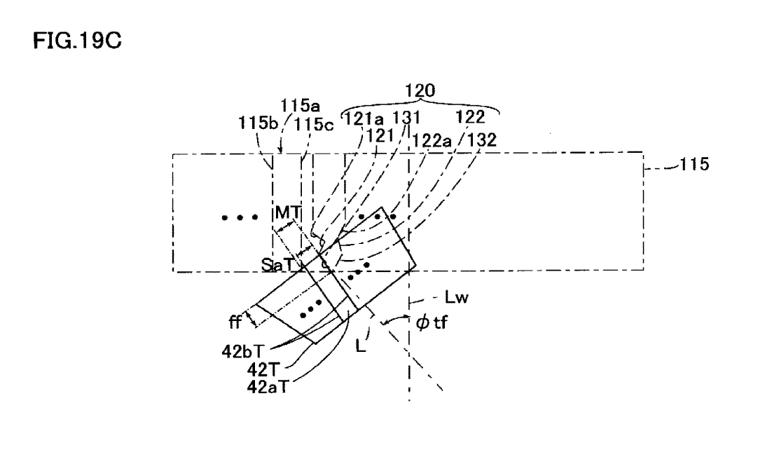

In the above-described example, the case of cutting the left chamfered tooth flank 131 and the right chamfered tooth flank 132 which constitute the gear coming-off preventing portions 120 of the sleeve 115 respectively by using two machining tools 42 (the first machining tool 42L and the second machining tool 42R) has been described. The left chamfered tooth flank 131 and the right chamfered tooth flank 132 may also be cut by using one machining tool 42T in the same manner as the one machining tool 42 which is capable of cutting the left tapered tooth flank 121 and the right tapered tooth flank 122 (see FIG. 19A, FIG. 19B, and FIG. 19C, which correspond to FIG. 16A, FIG. 16B, and FIG. 16C).

In the case of the machining tool 42T as well, in the same manner as the first machining tool 42L and the second machining tool 42R, the cutting blade 42aT of the machining tool 42T needs to have a shape which definitely allows the left chamfered tooth flank 131 and the right chamfered tooth flank 132 to be cut without interference with the adjacent inner teeth 115a while cutting the inner teeth 115a. The machining tool 42T has a cutting edge width of SaT, a torsion angle of βT, a tooth flank distance on the right chamfered tooth flank 132 of KT, a tooth flank distance on the left chamfered tooth flank 131 of MT, an intersection angle when cutting the right chamfered tooth flank 132 of ϕtr, and an intersection angle when cutting the left chamfered tooth flank 131 of ϕtf.

The design of the machining tool 42T is performed by the tool design part 102 of the control apparatus 100 in the same process as the process described in conjunction with FIG. 13 and FIG. 15, and thus detailed description will be omitted. The process of the tool state computing part 103 relating to the machining tool 42T is the same as the process described in conjunction with FIG. 3, and the process of the machining control part 101 is the same as the process described in conjunction with FIG. 4 except for the point that tool replacement is not performed, and thus detailed description will be omitted.

### 12. Machining Tool for Machining Second Alternative Shape

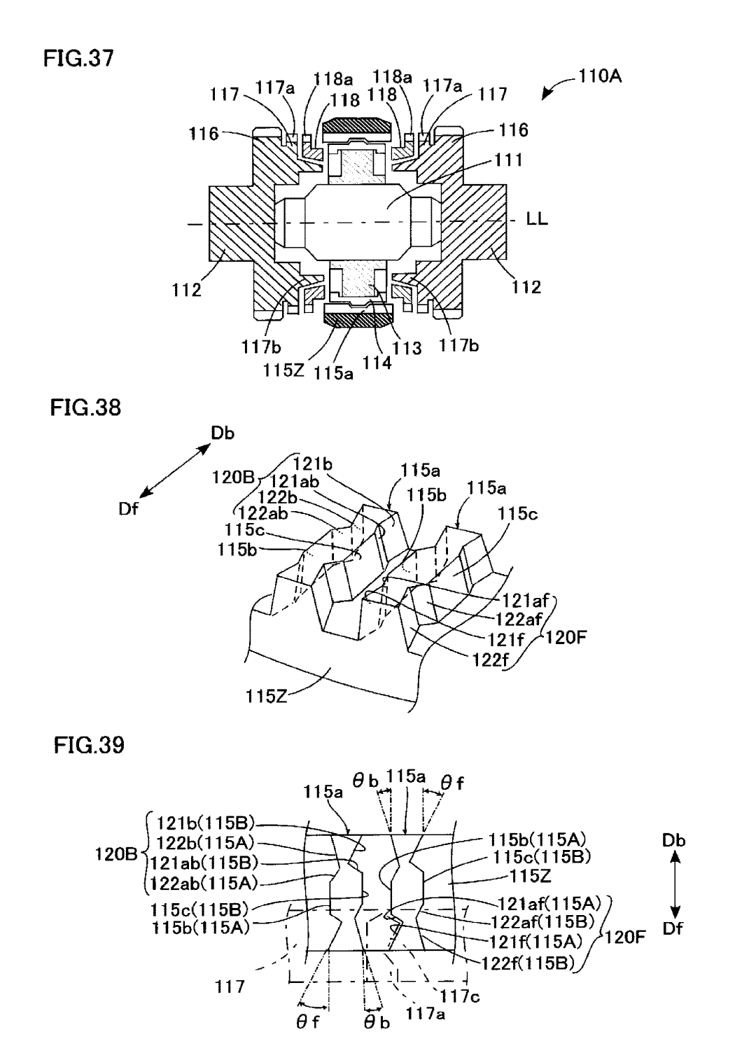

First, the second alternative shape will be described. In the above-described example, as illustrated in FIG. 21, the synchromesh mechanism 110 in which the main drive gear 116, the clutch gear 117, and the synchronizer ring 118 are disposed on one side of the sleeve 115 has been described. However, as illustrated in FIG. 37, a synchromesh mechanism 110A includes pairs of the main drive gears 116, the clutch gears 117, and the synchronizer rings 118 disposed on both sides of a sleeve 115Z. In FIG. 37, the same members as FIG. 21 are denoted by the same reference numerals, and detailed description will be omitted. The operation of the synchromesh mechanism 110A, although including a leftward movement and a rightward movement in FIG. 37, is the same as the operation of the synchromesh mechanism 110 in FIG. 21, and thus detailed description will be omitted.

The synchromesh mechanism 110A is provided with tapered gear coming-off preventing portions 120B, 120F on the inner teeth 115a of the sleeve 115Z on one side (hereinafter, referred to simply as “one side Db of the rotation axis”) and the other side (hereinafter, referred to simply as “the other side Df of the rotation axis”) thereof in the direction of the rotation axis LL of the sleeve 115Z, and tapered gear coming-off preventing portions 117c, 117c that taper-fit the gear coming-off preventing portions 120B, 120F on the outer teeth 117a, 117a of the respective clutch gears 117 as illustrated in FIG. 38 and FIG. 39 for preventing the outer teeth 117a of the clutch gears 117 and the inner teeth 115a of the sleeve 115Z from coming off during traveling.

In FIG. 39, only the outer teeth 117a of the clutch gear 117 on the gear coming-off preventing portion 120F side are shown. The gear coming-off preventing portions 120B, 120F in this example are formed into a point symmetry shape with respect to a virtual point at a center on a top surface of the inner tooth 115a in a direction of the rotation axis LL of the sleeve 115Z. In the following description, the side surface 115A of the inner tooth 115a of the sleeve 115Z on the left side of the drawing is referred to as “left side surface 115A” and a side surface 115B of the inner tooth 115a of the sleeve 115Z on the right side of the drawing is referred to as “right side surface 115B”.

The left side surface 115A of the inner tooth 115a of the sleeve 115Z includes a left tooth flank 115b (which corresponds to the “fifth tooth flank”), a tooth flank 121f (hereinafter, referred to as “other-side left tapered tooth flank 121f”, which corresponds to “sixth tooth flank”) provided on the left side surface 115A on the other side Df of the rotation axis so as to have a torsion angle different from the left tooth flank 115b, and a tooth flank 122b (hereinafter, referred to as “the one-side left tapered tooth flank 122b, which corresponds to “seventh tooth flank”) provided on the left side surface 115A on the one side Db of the rotation axis so as to have a torsion angle different from the left tooth flank 115b.

The right side surface 115B of the inner tooth 115a of the sleeve 115Z includes a right tooth flank 115c (which corresponds to the “eighth tooth flank”), a tooth flank 121b (hereinafter, referred to as “one-side right tapered tooth flank 121b”, which corresponds to “ninth tooth flank”) provided on the one side Db of the rotation axis of the right side surface 115B so as to have a torsion angle different from the right tooth flank 115c, and a tooth flank 122b (hereinafter, referred to as “the other-side right tapered tooth flank 122f, which corresponds to “tenth tooth flank”) provided on the right side surface 115B on the other side Df of the rotation axis so as to have a torsion angle different from the right tooth flank 115c.

In this example, the torsion angle of the left tooth flanks 115b is 0 degree, and the torsion angles of the other-side left tapered tooth flank 121f and the one-side right tapered tooth flank 121b are θf degrees. The torsion angle of the right tooth flank 115c is 0 degree, and the torsion angles of the one-side left tapered tooth flank 122b and the other-side right tapered tooth flank 122f are θb degrees. The other-side left tapered tooth flank 121f and a tooth flank 121af that connects the other-side left tapered tooth flank 121f and the left tooth flank 115b (hereinafter, referred to as “other-side left sub tooth flank 121af”), and the other-side right tapered tooth flank 122f and a tooth flank 122af that connects the other-side right tapered tooth flank 122f and the right tooth flank 115c (hereinafter, referred to as “other-side right sub tooth flank 122af”) constitute the gear coming-off preventing portion 120F.

The one-side left tapered tooth flank 122b and a tooth flank 122ab that connects the one-side left tapered tooth flank 122b and the left tooth flank 115b (hereinafter, referred to as “one-side left sub tooth flank 122ab”), and the one-side right tapered tooth flank 121b and a tooth flank 121ab that connects the one-side right tapered tooth flank 121b and the right tooth flank 115c (hereinafter, referred to as “one-side right sub tooth flank 121ab”) constitute the gear coming-off preventing portion 120B. The gear coming-off prevention is achieved by taper fitting between the other-side left tapered tooth flank 121f and the gear coming-off preventing portions 117c and also by taper fitting between the one-side right tapered tooth flank 121b and the gear coming-off preventing portion 117c.

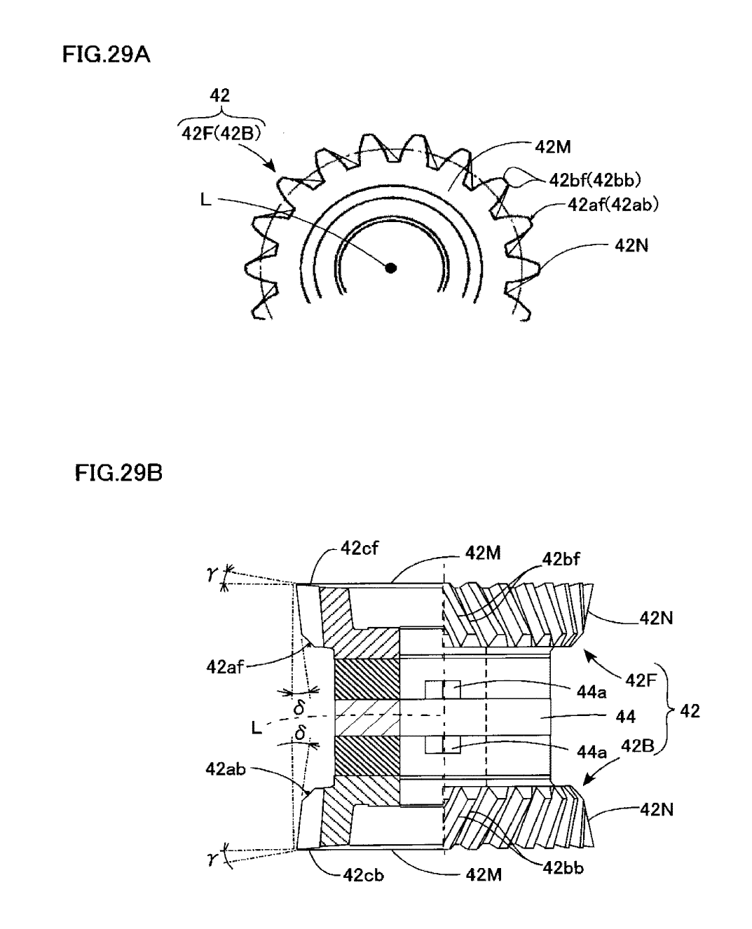

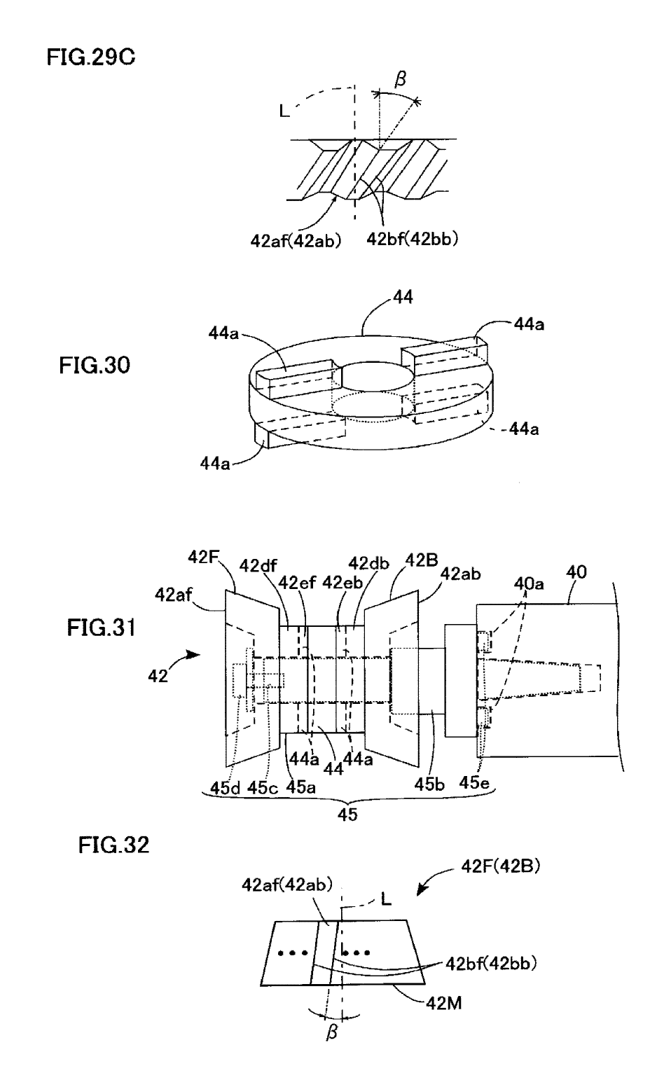

Here, the gear coming-off preventing portions 120B, 120F may be formed by cutting the inner teeth 115a of the sleeve 115Z formed by broaching or gear shapering with two machining tools. However, positional alignment is required every time when the tool is replaced and for each tool, which may result in elongated machining time and lower machining accuracy. Therefore, the above-described gear machining device 1 is configured to firstly form the inner teeth 115a of the sleeve 115Z by broaching, gear shapering, or the like, and then form the gear coming-off preventing portions 120F, 120B, respectively, on the inner teeth 115a of the sleeve 115Z respectively by cutting by means of one machining tool 42 having two cutting blades (first cutting blade 42af, second cutting blade 42ab, (see FIG. 29B) described later.

In other words, the sleeve 115Z having the inner teeth 115a formed thereon and the machining tool 42 are rotated synchronously, and the first cutting blade 42af of the machining tool 42 is fed from the other side Df of the rotation axis to the one side Db of the rotation axis in the direction of the rotation axis Lw of the workpiece W to cut and form the gear coming-off preventing portion 120F, while the second cutting blade 42ab of the machining tool 42 is fed from the one side Db of the rotation axis to the other side Df of the rotation axis in the direction of the rotation axis Lw of the workpiece W to cut and form the gear coming-off preventing portion 120B. Accordingly, the positional alignment is not required every time when the tool is replaced and for each tool, so that the machining time required for the gear coming-off preventing portions 120F, 120B is reduced compared with the related art, and the machining accuracy of the gear coming-off preventing portions 120F, 120B is improved compared with the related art.

The machining tool 42 will be described now. As illustrated in FIG. 29A and FIG. 29B, the machining tool 42 includes the first tool 42F, the second tool 42B, and the collar 44 held between the first machining tool 42F and the second tool 42B, and in this example, the first machining tool 42F and the second tool 42B have the same shape. The machining tool 42 includes the first tool 42F disposed so that a rake face 42cf of the first cutting blade 42af of the first tool 42F faces one side of the machining tool 42 in the direction of the tool axis (rotation axis) L and the second tool 42B disposed so that a rake face 42cb of the second cutting blade 42ab of the second tool 42B faces the other side of the machining tool 42 in the direction of the tool axis L, and the collar 44 disposed between the first tool 42F and the second tool 42B.

As illustrated in FIG. 29A, the first cutting blade 42af (the second cutting blade 42ab) when viewing the machining tool 42 from the tool end surface 42M side of the first tool 42F in the direction of the tool axis L in this example has the same shape as the involute curve. As illustrated in FIG. 29B, the first cutting blade 42af of the first tool 42F and the second cutting blade 42ab of the second tool 42B have a rake angle inclined by an angle γ with respect to a plane perpendicular to the tool axis L on the tool end surface 42M side, and a front clearance angle inclined by an angle δ with respect to a straight line parallel to the tool axis L on a tool peripheral surface 42N side. As illustrated in FIG. 29C, blade traces 42bf (42bb) of the first cutting blade 42af (second cutting blade 42ab) have a torsion angle inclined by an angle β with respect to a straight line parallel to the tool axis L.

As illustrated in FIG. 30, the collar 44 is formed into a cylindrical shape, and both end surfaces of the collar 44 are each provided with two cuboid detent keys 44a extending in the radial direction at 180 degrees intervals. As illustrated in FIG. 31, when assembling the machining tool 42 to the tool holder 45, the second tool 42B is fitted on the tool mounting axis 45a on the distal side of a tool holder 45 with the second cutting blade 42ab facing toward the main body 45b side of the tool holder 45, and then the collar 44 is inserted.

Subsequently, the first tool 42F is inserted with the first cutting blade 42af facing a distal end side (outside) of the tool mounting axis 45a, and finally a bolt with washer 45d is fastened into a screw hole 45c provided at a distal end of the tool mounting axis 45a. At this time, the respective keys 44a of the collar 44 are fitted into key grooves 42ef provided on the shaft portion 42df of the first tool 42F and the key grooves 42eb provided on the shaft portion 42db of the second tool 42B. Accordingly, the first cutting blade 42af of the first tool 42F and the second cutting blade 42ab of the second tool 42B are allowed to rotate in the same phase.

The tool holder 45 having the machining tool 42 mounted thereon is stored in a tool stocker of the automatic tool replacement device, is taken out from the tool stocker with a tool replacement arm of the automatic tool replacement device and is attached to the rotary main spindle 40 before starting machining. At this time, keys 45e provided on the tool holder 45 are fit to key grooves 40a provided on the rotary main spindle 40. Although the keys 45e of the tool holder 45 are fitted loosely into the key grooves 40a of the rotary main spindle 40, the looseness is disappeared by rotating the rotary main spindle 40 while holding the tool holder 45 having the machining tool 42 attached thereto with the tool replacement arm, so that the rotational phase of the machining tool 42 with respect to the rotary main spindle 40 is set. Subsequently, the tool holder 45 is clamped by the rotary main spindle 40 and is released from being held by the tool replacement arm.

Here, examples of methods to be taken for cutting the other-side left tapered tooth flanks 121f (one-side right tapered tooth flanks 121b) and the other-side right tapered tooth flanks 122f (one-side left tapered tooth flanks 122b) at different torsion angles with the first tool 42F (second tool 42B) include a method of using a machining tool 42 including first cutting blades 42af (second cutting blades 42ab) having a right blade surface and a left blade surface at different torsion angles, and a method of using the machining tool 42 including first cutting blades 42af (second cutting blades 42ab) having a left blade surface and a right blade surface at the same torsion angle.

In this example, a case where the machining tool 42 including the first cutting blades 42af (second cutting blades 42ab) having the left blade surface and the right blade surface at the same torsion angle are used for cutting will be described. In this case, the intersection angle ϕf of the first tool 42F (second tool 42B) for cutting the other-side left tapered tooth flank 121f (one-side right tapered tooth flank 121b) and the intersection angle ϕb of the first machining tool 42F (second tool 42B) for cutting the other-side right tapered tooth flank 122f (one-side left tapered tooth flank 122b) need to be differentiated.

The first tool 42F and the second tool 42B may be designed by using an above-described expression (1)-(10) (the suffixes are different), so that detailed description will be omitted. As described thus far, as illustrated in FIG. 32, the first tool 42F and the second tool 42B are designed so that the blade traces 42bf of the first cutting blade 42af and the blade traces 42bb of the second cutting blade 42ab have a torsion angle β inclined from lower left to upper right when viewing the tool end surface 42M downward in the drawing from a direction perpendicular to the tool axis L.

Designs of the first tool 42F and the second tool 42B of the machining tool 42 are performed by the tool design part 102 of the control apparatus 100, setting of the tool state of the machining tool 42 is performed by the tool state computing part 103, and cutting with the machining tool 42 is performed by the machining control part 101. As the process to be performed by the tool state computing part 103 is the same as the example described above, detailed description is omitted and the process to be performed by the tool design part 102 and the process to be performed by the machining control part 101 will be described in the following description.

### 13. Process to be Performed by Tool Design Part of Control Apparatus

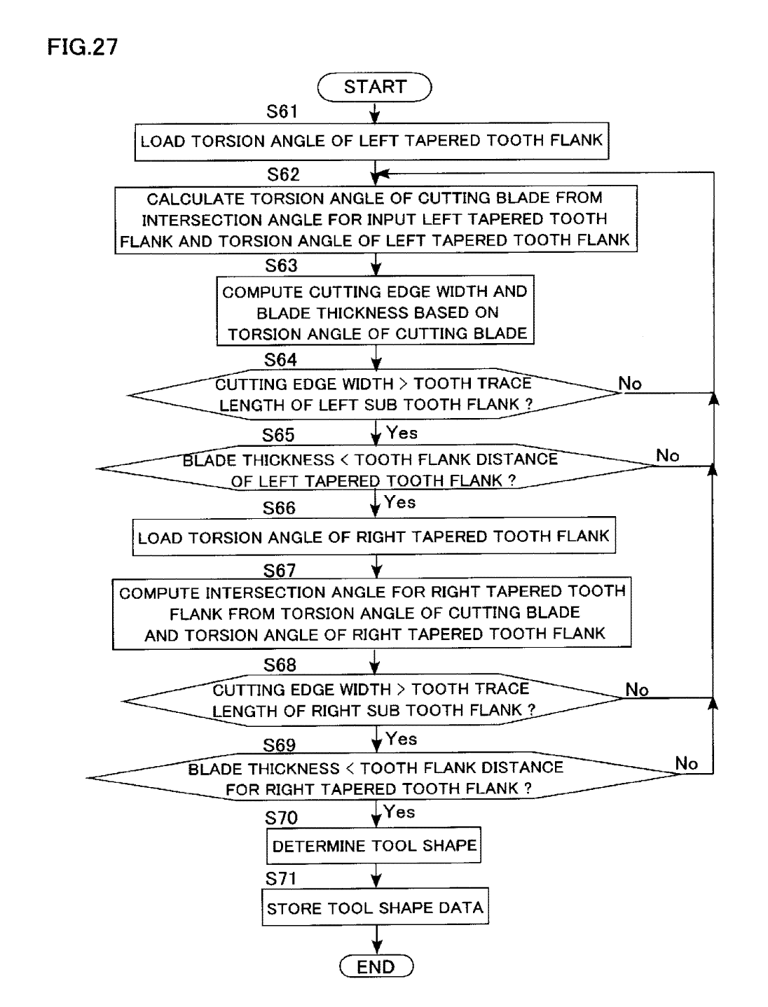

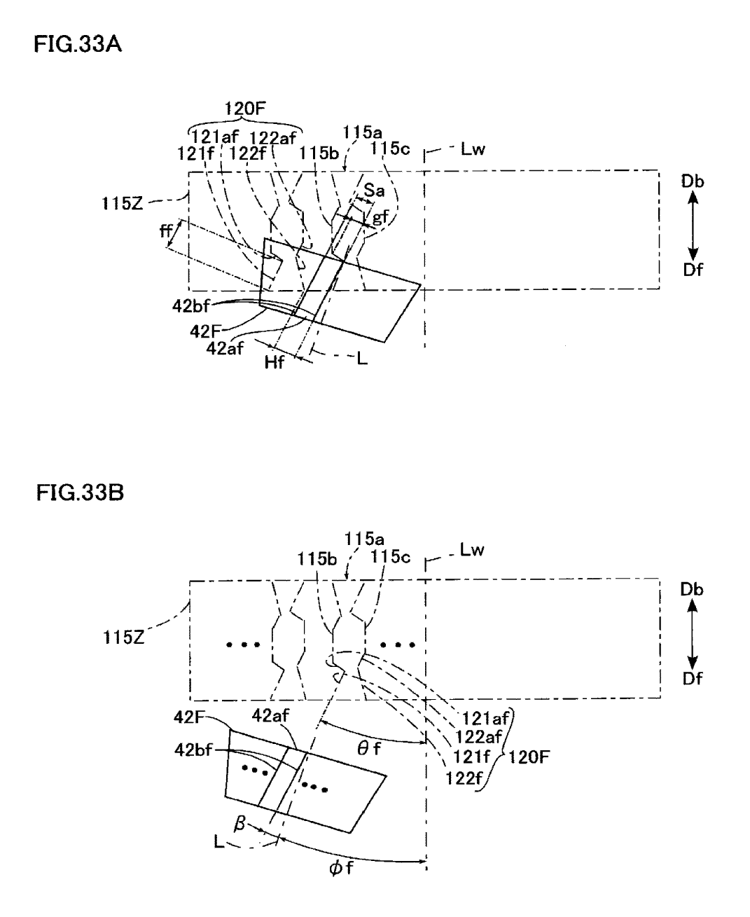

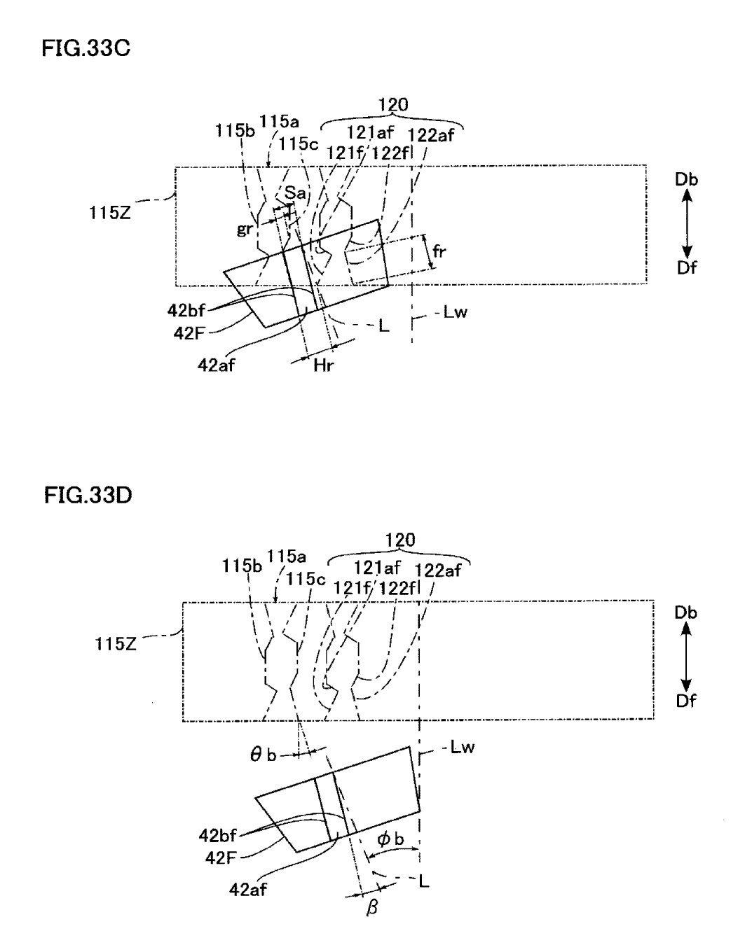

Subsequently, designing process to be performed by the tool design part 102 of the control apparatus 100 on the first tool 42F will be described with reference to FIG. 27, FIG. 33A, FIG. 33B, FIG. 33C, and FIG. 33D. A design of the second tool 42B is the same as a design of the first tool 42F, and thus description is omitted. Note that data relating to the gear coming-off preventing portions 120F, that is, the torsion angle θf and the tooth trace length ff of the other-side left tapered tooth flank 121f, the tooth trace length gf and the tooth flank distance Hf of the other-side left sub tooth flank 121af, the torsion angle θb and the tooth trace length fr of the other-side right tapered tooth flank 122f, and the tooth trace length gr and the tooth flank distance Hr of the other-side right sub tooth flank 122af are assumed to be stored in the memory 104 in advance. In addition, data relating to the first tool 42F such as the number of blades Z, the cutting edge circle diameter da, the reference circle diameter d, the addendum ha, the module m, the addendum modification coefficient λ, the pressure angle α, the front pressure angle αt, and the cutting edge pressure angle αa are assumed to be stored in the memory 104 in advance.

The tool design part 102 of the control apparatus 100 loads the torsion angle θf of the other-side left tapered tooth flank 121f from the memory 104 (Step S61 in FIG. 27). Then, the tool design part 102 obtains a difference between the intersection angle θf of the machining tool 42 input by an operator when cutting the other-side left tapered tooth flank 121f and a loaded torsion angle θf of the other-side left tapered tooth flank 121f as a torsion angle β of the blade traces 42bf of the first cutting blade 42af of the first tool 42F (Step S62 in FIG. 27).

The tool design part 102 loads the number of blades Z or the like of the first tool 42F from the memory 104 and obtains the cutting edge width Sa and the blade thickness Ta of the first cutting blade 42af based on the number of blades Z or the like of the loaded first tool 42F and the torsion angle β of the blade traces 42bf of the first cutting blade 42af (Step S63 in FIG. 27). The tool design part 102 reads out the tooth trace length gf of the other-side left sub tooth flank 121af from the memory 104, and determines whether or not the obtained cutting edge width Sa of the first cutting blade 42af is larger than the tooth trace length gf of the other-side left sub tooth flank 121af (Step S64 in FIG. 27).

When the obtained cutting edge width Sa of the first cutting blade 42af is equal to or smaller than the tooth trace length gf of the other-side left sub tooth flank 121af, the tool design part 102 returns back to Step S62 and repeats the above-described process. In contrast, when the cutting edge width Sa of the first cutting blade 42af is increased to a width larger than the tooth trace length gf of the other-side left sub tooth flank 121af, the tool designed part 102 reads out the tooth flank distance Hf from the memory 104, and determines whether or not the obtained blade thickness Ta of the first cutting blade 42af is smaller than the tooth flank distance Hf on the other-side left tapered tooth flank 121f side (Step S65 in FIG. 27).

When the obtained blade thickness Ta of the first cutting blade 42af is equal to or larger than the tooth flank distance Hf on the other-side left tapered tooth flank 121f side, the tool design part 102 returns back to Step S62 and repeats the above-described process. In contrast, when the blade thickness Ta of the first cutting blade 42af becomes smaller than the tooth flank distance Hf on the other-side left tapered tooth flank 121f side, the tool design part 102 reads a torsion angle θb of the other-side right tapered tooth flank 122f from the memory 104 (Step S66 in FIG. 27). Then, the tool design part 102 obtains a difference between the torsion angle β of the blade traces 42bf of the first cutting blade 42af of the first tool 42F obtained in Step S2 and the loaded torsion angle θb of the other-side right tapered tooth flank 122f as an intersection angle ϕb of the machining tool 42 when cutting the other-side right tapered tooth flank 122f (Step S67 in FIG. 27).

The tool design part 102 reads out the tooth trace length gr of the other-side right sub tooth flank 122af from the memory 104, and determines whether or not the obtained cutting edge width Sa of the first cutting blade 42af obtained in Step S33 is larger than the tooth trace length gr of the other-side right sub tooth flank 122af (Step S68 in FIG. 27). When the obtained cutting edge width Sa is equal to or smaller than the tooth trace length gr of the other-side right sub tooth flank 122af, the tool design part 102 returns back to Step S62 and repeats the above-described process. In contrast, when the cutting edge width Sa is increased to a width larger than the tooth trace length gr of the other-side right sub tooth flank 122af, the tool design part 102 reads out the tooth flank distance Hr from the memory 104, and determines whether or not the obtained blade thickness Ta is smaller than the tooth flank distance Hr on the other-side right tapered tooth flank 122f side (Step S69 in FIG. 27).

When the blade thickness Ta is equal to or larger than the tooth flank distance Hr on the other-side right tapered tooth flank 122f side, the tool design part 102 returns back to Step S62 and repeats the above-described process. In contrast, when the blade thickness Ta is reduced to a thickness smaller than the tooth flank distance Hr on the other-side right tapered tooth flank 122f, the tool design part 102 determines the shape of the first tool 42F based on the obtained torsion angle β of the blade traces 42bf of the first cutting blade 42af (Step S70 in FIG. 27), stores the determined shape data of the first tool 42F in the memory 104 (Step S71 in FIG. 27), and ends the entire process. Accordingly, the first tool 42F having the optimum first cutting blade 42af (the second tool 42B having the second cutting blade 42ab) is designed.

### 14. Process to be Performed by Machining Control Part of Control Apparatus

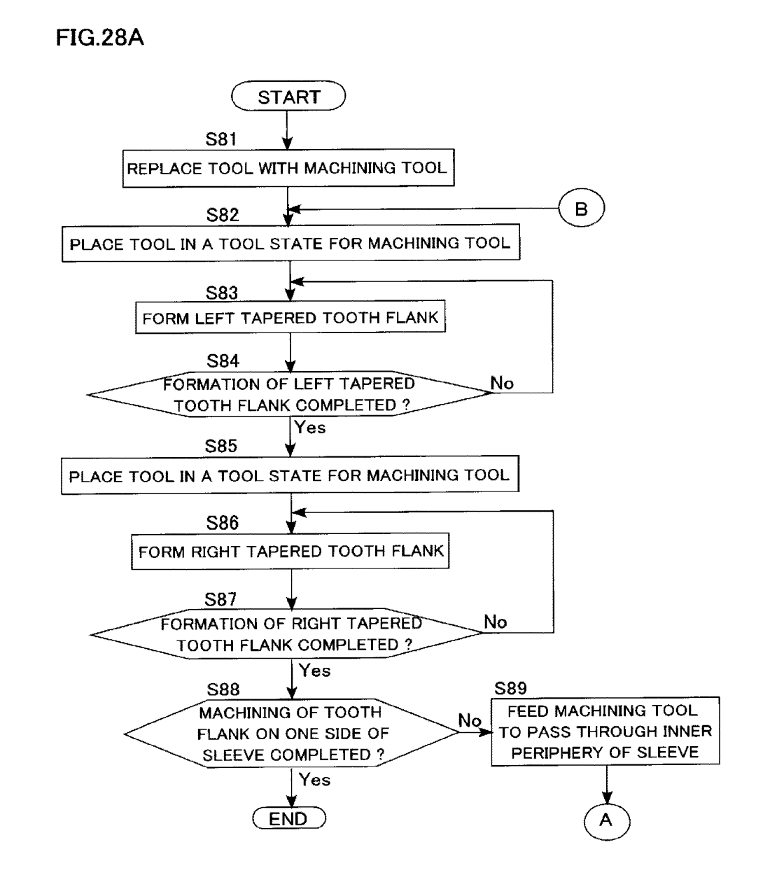

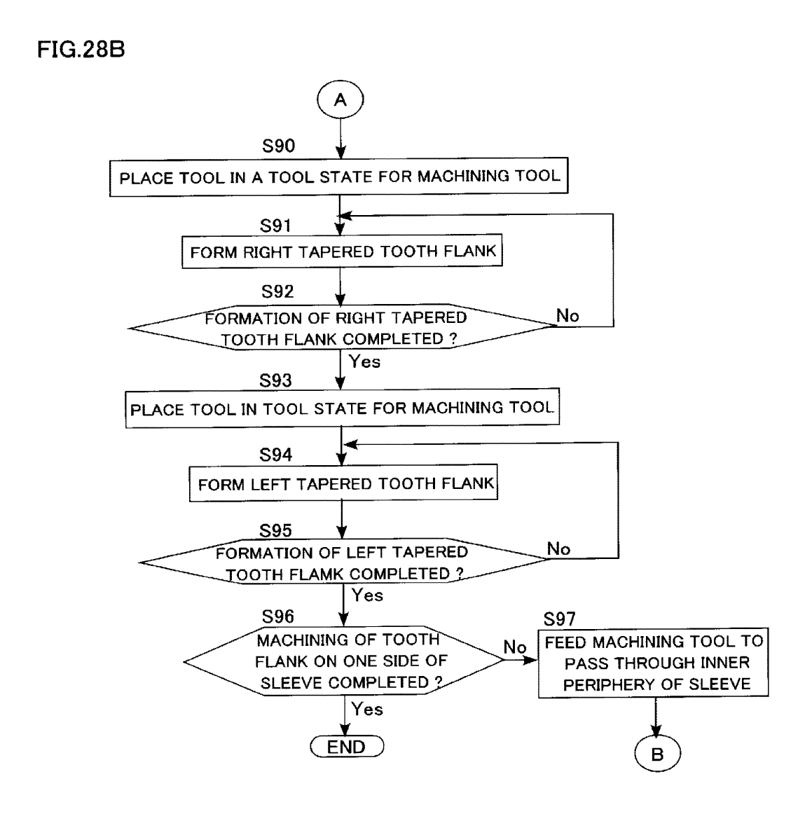

Referring now to FIG. 28A and FIG. 28B, the process to be performed by the machining control part 101 of the control apparatus 100 will be described. It is assumed here that an operator manufactures the first tool 42F and the second tool 42B based on the respective shape data of the first tool 42F and the second tool 42B designed by the tool design part 102, assembles the same to the tool holder 45 and stores the same in the tool stocker of the automatic tool replacement device of the gear machining device 1. It is also assumed that the sleeve 115Z is mounted on the workpiece holder 80 of the gear machining device 1, and the inner teeth 115a are formed by turning, broaching, or the like.

The machining control part 101 of the control apparatus 100 replaces the machining tool of the previous machining step (turning or broaching, etc.) with the machining tool 42 with the automatic tool replacement device (Step S81 in FIG. 28A). Then, the machining control part 101 places the machining tool 42 and the sleeve 115Z so that a tool state of the machining tool 42 for machining the other-side left tapered tooth flank 121f of the sleeve 115Z obtained by the tool state computing part 103 is achieved (Step S82 in FIG. 28A). Specifically, as illustrated in FIG. 33B, the machining tool 42 and the sleeve 115Z are disposed so that the first tool 42F of the machining tool 42 held by the rotary main spindle 40 faces the sleeve 115Z held by the workpiece holder 80 and that the machining tool 42 is placed at an axial position (for example, offset amount 0) and an intersection angle θf to be taken by the machining tool 42 when forming the other-side left tapered tooth flank 121f obtained by the tool state computing part 103.

The machining control part 101 feeds the machining tool 42 in the direction of the rotation axis Lw of the sleeve 115Z so that the first tool 42F side moves toward the sleeve 115Z while rotating the machining tool 42 synchronously with the sleeve 115Z and cuts the inner tooth 115a to form the other-side left tapered tooth flank 121f including the other-side left sub tooth flank 121af on the inner tooth 115a (Step S83 in FIG. 28A).

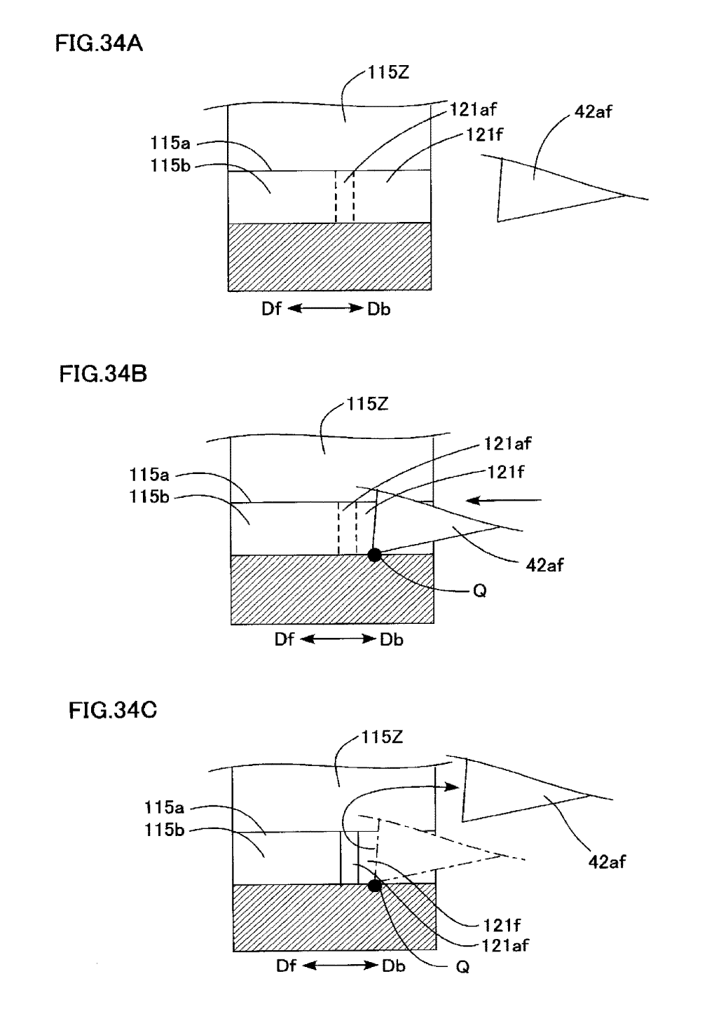

In other words, as illustrated in FIG. 34A to FIG. 34C, the first tool 42F forms the other-side left tapered tooth flank 121f including the other-side left sub tooth flank 121af on the inner teeth 115a by one or more times of cutting operation in the direction of the rotation axis Lw of the sleeve 115Z. The first tool 42F at this time needs to perform a feeding operation and a returning operation in the opposite direction from the feeding operation. However, as illustrated in FIG. 34C, the reversing operation is associated with an inertial force. Therefore, the feeding operation of the first tool 42F ends at a point Q, which is shorter by a predetermined amount than the tooth trace length ff of the other-side left tapered tooth flank 121f which can form the other-side left tapered tooth flank 121f including the other-side left sub tooth flank 121af, and is transferred to the returning operation. The feed end point Q may be obtained by measurement with a sensor or the like. However, if the feeding amount is sufficiently accurate with respect to the required machining accuracy, measurement is not necessary and point Q may be adjusted by the feeding amount. In other words, accurate machining is achieved by a cutting work while adjusting the feeding amount so that machining up to the point Q is ensured.

Then, when cutting of the other-side left tapered tooth flank 121f is completed (Step S84 in FIG. 28A), the machining control part 101 places the machining tool 42 and the sleeve 115Z so that a tool state of the machining tool 42 for machining the other-side right tapered tooth flank 122f of the sleeve 115Z obtained by the tool state computing part 103 is achieved (Step S85 in FIG. 28A). Specifically, as illustrated in FIG. 33D, the machining tool 42 and the sleeve 115Z are disposed so that the first tool 42F of the machining tool 42 held by the rotary main spindle 40 faces the sleeve 115Z held by the workpiece holder 80 and that the machining tool 42 is placed at an axial position (for example, offset amount 0) and an intersection angle ϕb to be taken by the machining tool 42 when forming the other-side right tapered tooth flank 122f obtained by the tool state computing part 103.

The machining control part 101 feeds the machining tool 42 in the direction of the rotation axis Lw of the sleeve 115Z so that the first tool 42F side moves toward the sleeve 115Z while rotating the machining tool 42 synchronously with the sleeve 115Z and cuts the inner tooth 115a to form the other-side right tapered tooth flank 122f including the other-side right sub tooth flank 122af on the inner tooth 115a (Step S86 in FIG. 28A).

When the cutting of the other-side right tapered tooth flank 122f is completed (Step S87 in FIG. 28A), the machining control part 101 determines whether or not machining of the gear coming-off preventing portion 120B on one side of the sleeve 115Z is completed (Step S88 in FIG. 28A). When the machining control part 101 determines that machining of the gear coming-off preventing portion 120B on one side of the sleeve 115Z is completed, the machining control part 101 terminates all the processes. In contrast, when the the machining control part 101 determines that machining of the gear coming-off preventing portion 120B on one side of the sleeve 115Z is not completed, the machining control part 101 feeds the machining tool 42 in the direction of the rotation axis Lw of the sleeve 115Z to pass through the inner periphery of the sleeve 115Z (Step S89 in FIG. 28A), and the procedure goes to Step S90 in FIG. 28B.

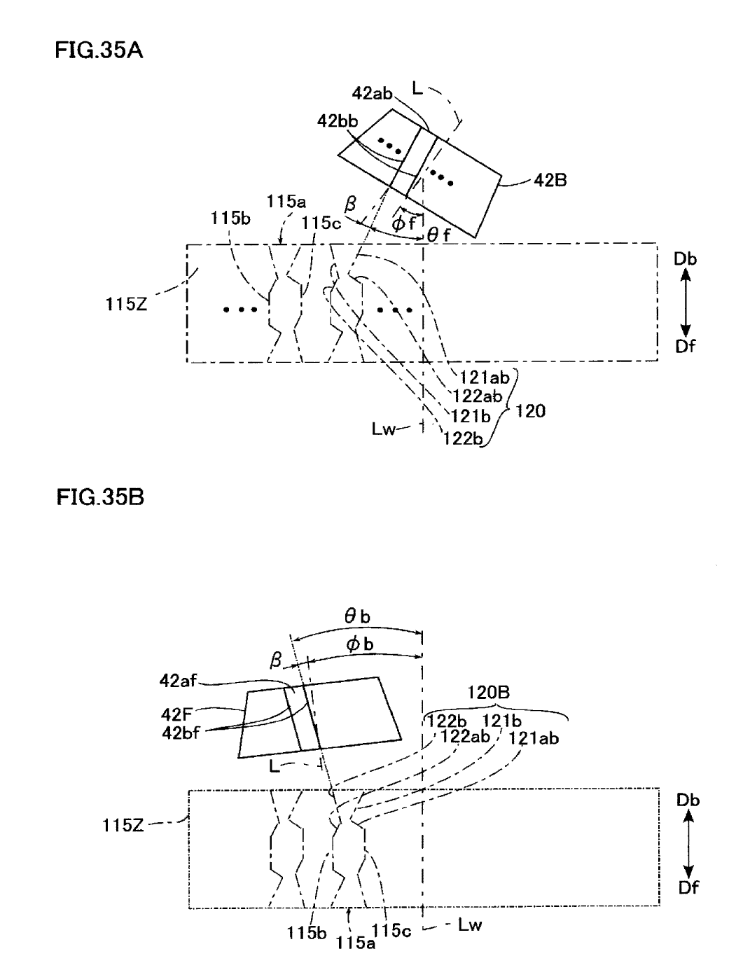

Then, the machining control part 101 places the machining tool 42 and the sleeve 115Z so that a tool state of the machining tool 42 for machining the one-side right tapered tooth flank 121b of the sleeve 115Z obtained by the tool state computing part 103 is achieved (Step S90 in FIG. 28B). Specifically, as illustrated in FIG. 35A, the machining tool 42 and the sleeve 115Z are disposed so that the second tool 42B of the machining tool 42 held by the rotary main spindle 40 faces the sleeve 115Z held by the workpiece holder 80 and that the machining tool 42 is placed at an axial position (for example, offset amount 0) and an intersection angle ϕf to be taken by the machining tool 42 when forming the one-side right tapered tooth flank 121b obtained by the tool state computing part 103.

The machining control part 101 returns the machining tool 42 in the direction of the rotation axis Lw of the sleeve 115Z so that the second tool 42B side moves toward the sleeve 115Z while rotating the machining tool 42 synchronously with the sleeve 115Z and cuts the inner tooth 115a to form the one-side right tapered tooth flank 121b including the one-side right sub tooth flank 121ab on the inner tooth 115a (Step S91 in FIG. 28B).

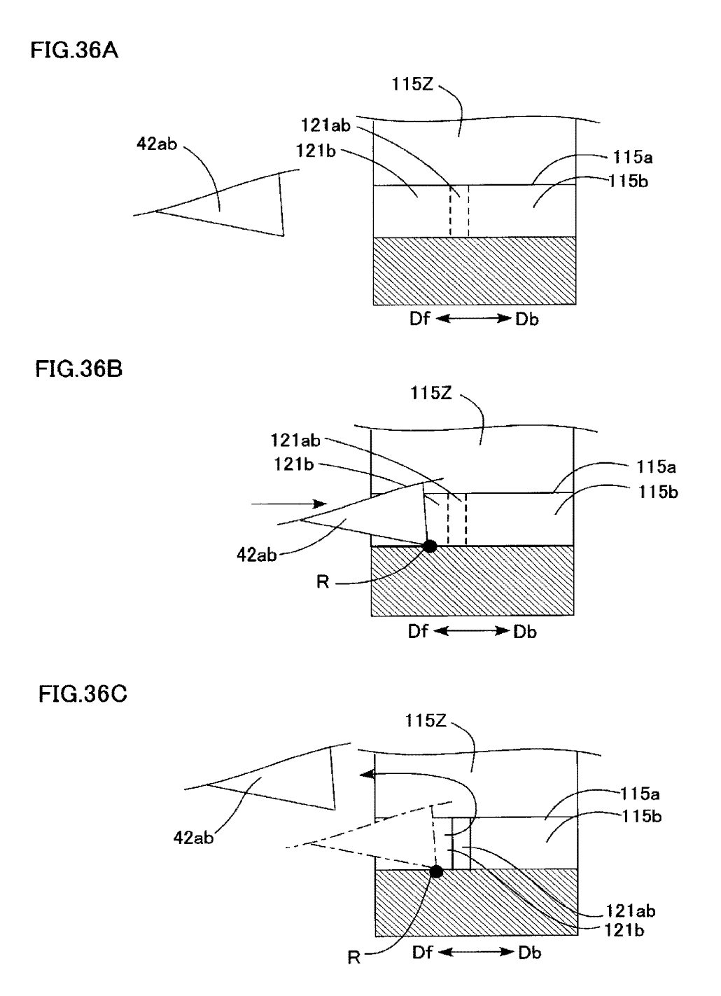

In other words, as illustrated in FIG. 36A to FIG. 36C, the second tool 42B forms the one-side right tapered tooth flank 121b including the one-side right sub tooth flank 121ab on the inner teeth 115a by one or more times of cutting operation in the direction of the rotation axis Lw of the sleeve 115Z. The second tool 42B at this time needs to perform a returning operation and a feeding operation. However, as illustrated in FIG. 36C, the reversing operation is associated with an inertial force. Therefore, the returning operation of the second tool 42B ends at a point R, which is shorter by a predetermined amount than the tooth trace length ff of the one-side right tapered tooth flank 121b which can form the one-side right tapered tooth flank 121b including the one-side right sub tooth flank 121ab, and is transferred to the feeding operation. The return end point R may be obtained by measurement with a sensor or the like. However, if the feeding amount is sufficiently accurate with respect to the required machining accuracy, measurement is not necessary and point R may be adjusted by the feeding amount. In other words, accurate machining is achieved by a cutting work while adjusting the feeding amount so that machining up to the point R is ensured.

Then, when cutting of the one-side right tapered tooth flank 121b is completed (Step S92 in FIG. 28B), the machining control part 101 places the machining tool 42 and the sleeve 115Z so that a tool state of the machining tool 42 for machining the one-side left tapered tooth flank 122b of the sleeve 115Z obtained by the tool state computing part 103 is achieved (Step S93 in FIG. 28B). Specifically, as illustrated in FIG. 35B, the machining tool 42 and the sleeve 115Z are disposed so that the second tool 42B of the machining tool 42 held by the rotary main spindle 40 faces the sleeve 115Z held by the workpiece holder 80 and that the machining tool 42 is placed at an axial position (for example, offset amount 0) and an intersection angle ϕb to be taken by the machining tool 42 when forming the one-side left tapered tooth flank 122b obtained by the tool state computing part 103.

The machining control part 101 returns the machining tool 42 in the direction of the rotation axis Lw of the sleeve 115Z so that the second tool 42B side moves toward the sleeve 115Z while rotating the machining tool 42 synchronously with the sleeve 115Z and cuts the inner tooth 115a to form the one-side left tapered tooth flank 122b including the one-side left sub tooth flank 122ab on the inner tooth 115a (Step S94 in FIG. 28B). When the cutting of the one-side left tapered tooth flank 122b is completed (Step S95 in FIG. 28B), the machining control part 101 determines whether or not machining of the gear coming-off preventing portion 120F on the other side of the sleeve 115Z is completed (Step S96 in FIG. 28B).

In contrast, when the machining control part 101 determines that machining of the gear coming-off preventing portion 120F on the other side of the sleeve 115Z is not completed, the machining control part 101 feeds the machining tool 42 in the direction of the rotation axis Lw of the sleeve 115Z to pass through the inner periphery of the sleeve 115Z (Step S97 of FIG. 28B), and then the procedure goes to Step S82 in FIG. 28A. In contrast, when the machining control part 101 determines that machining of the gear coming-off preventing portion 120F on the other side of the sleeve 115Z is completed, the machining control part 101 terminates all the processes.

### 15. Others

In the above-described examples, the case where the gear coming-off preventing portions 120 are formed on the already machined inner teeth 115a of the sleeve 115,115Z by cutting by means of the machining tools 42F, 42G, 42 has been described. However, the gear coming-off preventing portions 120 may be formed by rough machining the already machined inner teeth 115a of the sleeve 115,115Z by rolling while leaving a finishing allowance, and then finishing by cutting the finishing allowance with the machining tools 42F, 42G, 42. The same applies to the machining tools 42L, 42R, 42T.

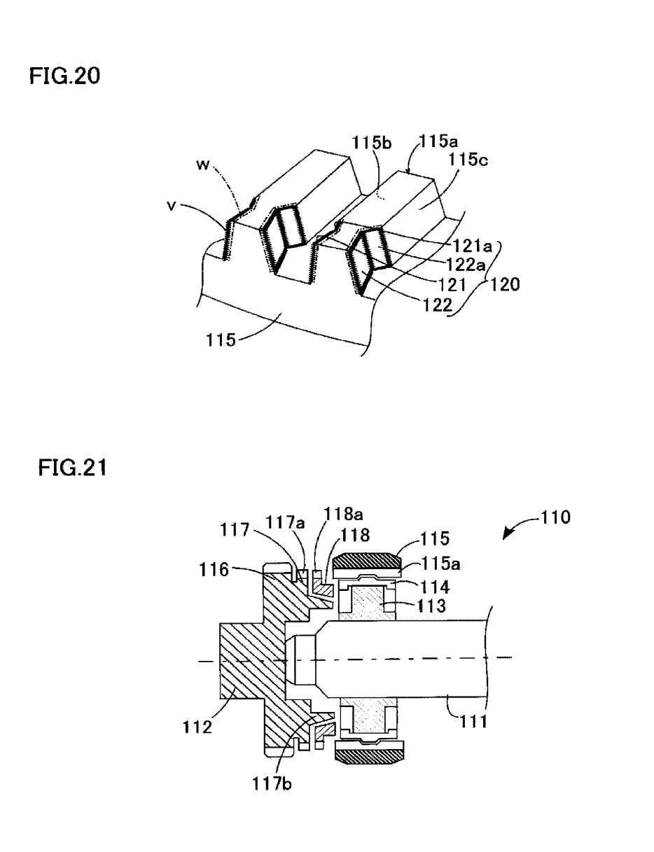

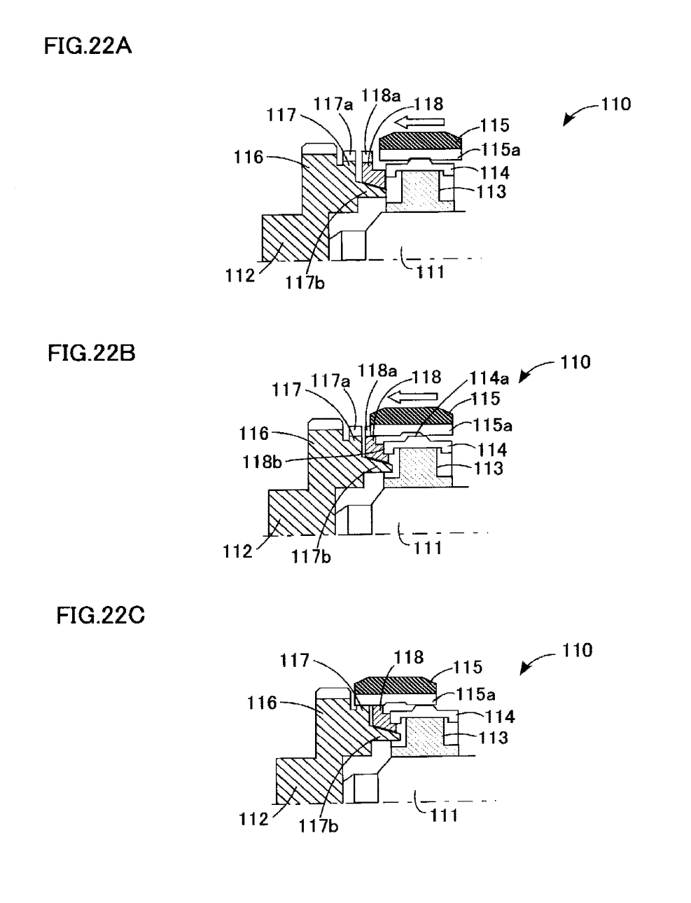

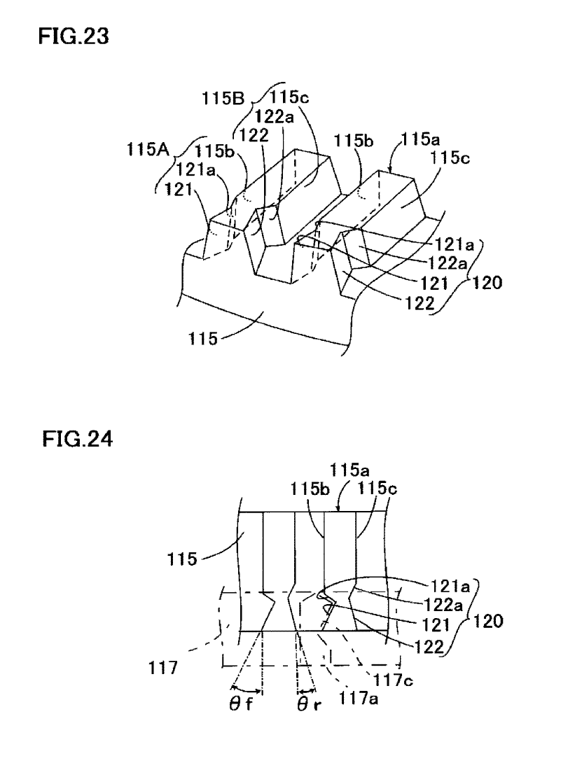

In this case, as illustrated in FIG. 20, burrs v are formed around the gear coming-off preventing portions 120 formed by rolling, but the burrs v may be removed together with the finishing allowance w (portions outside dot-and-dash lines in the drawing) by a finishing work by means of the machining tools 42F, 42G, 42. Therefore, the machining tools 42F, 42G, 42 are able to cut the left tapered tooth flank 121 including the left sub tooth flank 121a and the right tapered tooth flank 122 including the right sub tooth flank 122a with high degree of accuracy. The same applies to the machining tools 42L, 42R, 42T. The same applies to the gear coming-off preventing portions 120F, 120B.

In the above-described example, the case where the inner teeth 115a of the sleeves 115, 115Z are formed by broaching, gear shapering, or the like has been described. However, all the inner teeth 115a of the sleeves 115, 115Z and the gear coming-off preventing portions 120, 120F, 120B may be formed by cutting by means of the machining tools 42F, 42G, 42. The same applies to the machining tools 42L, 42R, 42T. Although the case of machining of the inner teeth has been described, machining of outer teeth is also possible.

Although the workpiece has been described as the sleeves 115, 115Z of the synchromesh mechanisms 110, 110A, the workpiece may be those having teeth to mesh such as gears or those having a cylindrical shape or a disk shape, and a plurality of tooth flanks (a plurality of different tooth traces (tooth shapes (tooth tips, tooth roots)) may be machined on one or both of inner periphery (inner teeth) and an outer periphery (outer teeth). Continuous changing tooth traces, the tooth shapes (tooth tips, tooth roots) such as crowning and relieving may also be machined in the same manner, and optimum (good state) engagement is achieved.

In the examples described above, the first tool 42F and the second tool 42B are formed separately, and the collar 44 is held between the first tool 42F and the second tool 42B to form the machining tool 42. However, the machining tool 42 having the first cutting blade 42af and the second cutting blade 42ab as a unified machining tool 42 is also applicable. Accordingly, assembly of the machining tool 42 to the tool holder 45 is facilitated.

In the above-described example, the gear machining device 1, which is a five-axis machining center, has an ability to rotate the sleeves 115, 115Z about the A axis. In contrast, the five-axis machining center may be configured to have an ability to rotate the machining tools 42F, 42R, 42, 42L, 42R, 42T about the A axis as a vertical machining center. Although the case of applying the invention to the machining center has been described, the same applies to a machine specific for gear machining.

### 16. Advantageous Effect of Embodiment

The gear machining device 1 of this embodiment is the gear machining device 1 including a machining tool 42F (42G, 42, 42L, 42R, 42T) to be used for machining a gear, the machining tool 42F (42G, 42, 42L, 42R, 42T) having a rotation axis L inclined with respect to a rotation axis Lw of a workpiece 115 and being fed relatively in the direction of the rotation axis Lw of the workpiece (sleeve 115) while being rotated synchronously with the workpiece 115, wherein a gear tooth 115a includes side surfaces 115A (115B) having a first tooth flank 115b (115c) and a second tooth flank 121 (122, 131, 132) having a torsion angle different from the first tooth flank 15b (115c),

the machining tool 42F (42G, 42, 42L, 42R, 42T) includes a cutting blade 42af (42ag, 42a, 42aL, 42aR, 42aT), and the cutting blade 42af (42ag, 42a, 42aL, 42aR, 42aT) has blade traces 42bf (42bg, 42b, 42bL, 42bR, 42bT) having a torsion angle βf (βg, β, βL, βR, βT) determined based on the torsion angle θf (θr, θL, θR) of the second tooth flank 121 (122, 131, 132) and an intersection angle ϕf (ϕg, ϕff, ϕrr, ϕL, ϕR, ϕtr, ϕtf) between the rotation axis Lw of the workpiece 115 and the rotation axis L of the machining tool 42F (42G, 42, 42L, 42R, 42T) so as to allow the second tooth flank 121 (122, 131, 132) to be machined on the pre-machined first tooth flank 115b (115c).

In the related art, the gear tooth having the first tooth flank 115b (115c) and the second tooth flank 121 (122, 131, 132) at different torsion angles is formed by plastic forming on the pre-machined first tooth flank 115b (115c) to form the second tooth flank 121 (122, 131, 132). Therefore, a problem of lowering of machining accuracy of the second tooth flank 121 (122, 131, 132) exists. However, in the gear machining device 1, since the second tooth flank 121 (122, 131, 132) is formed on the first tooth flank 115b (115c) by cutting, high degree of accuracy is achieved.

The side surfaces 115A on one side of the gear tooth (115a) has the first tooth flank 115b and the second tooth flank 121, (131) having the different torsion angle from the first tooth flank 115b, the side surfaces 115B on the other side of the gear tooth 115a have a third tooth flank 115c and a fourth tooth flank 122 (132) having a different torsion angle from the third tooth flank 115c, the machining tool includes a first machining tool 42F (42L) and a second machining tool 42G (42R), the blade traces 42bf (42bL) of the cutting blade 42af (42aL) of the first machining tool 42F (42L) have a torsion angle βf (βL) determined based on the torsion angle θf (θL) of the second tooth flank 121 (131) and an intersection angle ϕf (ϕL) between the rotation axis (Lw) of the workpiece 115 and a rotation axis (L) of the first machining tool 42F (42L) so as to allow the second tooth flank 121 (131) to be machined on the pre-machined first tooth flank 115b, and the blade traces 42bg (42bR) of the cutting blade 42ag (42aR) of the second machining tool 42G (42R) have a torsion angle βg (βR) determined based on the torsion angle θr (θR) of the fourth tooth flank 122 (132) and the intersection angle ϕg (ϕR) between the rotation axis Lw of the workpiece 115 and the rotation axis Lw of the second machining tool 42G (42R) so as to allow the fourth tooth flank 122 (132) to be machined on the pre-machined third tooth flank 115c.

Accordingly, as the first tooth flank 115b (115c) and the second tooth flank 121 (131), as well as the third tooth flank 115c and the fourth tooth flank 122 (132) may be formed by cutting with the first machining tool 42F (42L) and the second machining tool 42G (42R) even though the torsion angles are different, machining efficiency may be improved.

The side surfaces 115A on one side of the gear tooth 115a have the first tooth flank 115b and the second tooth flank 121 (131) having the different torsion angle from the first tooth flank 115b, the side surfaces 115B on the other side of the gear tooth 115a have a third tooth flank 115c and a fourth tooth flank 122 (132) having a different torsion angle from the third tooth flank 115c, the blade traces 42b (42bT) on one side of the cutting blade 42a (42aT) of the machining tool 42 (42T) have a torsion angle β (βT) determined based on the torsion angle θf (θL) of the second tooth flank 121 (131) and an intersection angle ϕf (ϕtf) for the second tooth flank between the rotation axis Lw of the workpiece 115 and the rotation axis L of the machining tool 42 (42T) so as to allow the second tooth flank 121 (131) to be machined on the pre-machined first tooth flank 115b, and the blade traces 42b (42bT) on the other side of the cutting blade 42a (42aT) of the machining tool 42 (42T) have the same torsion angle β (βT) as the blade traces 42b (42bT) on the one side of the cutting blade 42a (42aT) of the machining tool 42 (42T), and the machining tool 42 (42T) is set to an intersection angle ϕff (ϕtf) for the second tooth flank when machining the second tooth flank 121 (131) on the pre-machined first tooth flank 115b, and is set to an intersection angle ϕrr (ϕtr) for the fourth tooth flank determined based on a torsion angle θr (θR) of the fourth tooth flank 122 and the torsion angle β (βT) of the blade traces 42b (42bT) of the cutting blade 42a (42aT) on the other side of the machining tool 42 (42T) when machining the fourth tooth flank 122 (132) on the pre-machined third tooth flank 115c.

Accordingly, as the first tooth flank 115b and the second tooth flank 121 (131), as well as the third tooth flank 115c and the fourth tooth flank 122 (132) may be formed by cutting with one machining tool 42 (42T) even though the torsion angles are different, replacement of the tool is not necessary and machining efficiency may be significantly improved.

The second tooth flank 121 (131) and the fourth tooth flank 122 (132) are roughly machined by plastic forming, and

the machining tool 42F, 42G, 42 (42L, 42R, 42T) removes a burr generated on the second tooth flank 121 (131) and the fourth tooth flank 122 (132) when finishing the second tooth flank 121 (131) and the fourth tooth flank 122 (132).

The gear is a sleeve 115 of the synchromesh mechanism, and the tooth flanks 121 (131) and 122 (132) having different torsion angles are tooth flanks of the gear coming-off preventing portions 120 provided on the inner peripheral teeth of the sleeve 115. Accordingly, as machining accuracy of the second tooth flank 121 (131) and the fourth tooth flank 122 (132) which constitute the gear coming-off preventing portions 120 is increased by cutting, gear is reliably prevented from coming off. The tooth flank of the gear coming-off preventing portions 120 provided on the teeth 115a of the sleeve 115 are chamfered tooth flanks 131, 132 provided on the end surfaces of the teeth 115a of the sleeve 115 and the tapered tooth flanks 121, 122 continuing from the chamfered tooth flanks 131, 132. Smooth gear engagement is achieved by the chamfered tooth flanks 131, 132, and the tapered tooth flanks 121, 122 are reliably prevented from coming off.

A gear machining device 1 including: a machining tool 42 to be used for machining a gear, the machining tool 42 having a rotation axis L inclined with respect to a rotation axis (Lw) of a workpiece (sleeve 115Z), the machining tool 42 being fed relatively in the direction of the rotation axis L of the workpiece 115Z while being rotated synchronously with the workpiece 115Z, wherein a gear tooth 115a includes the left side surface 115A and the right side surface 115B (side surfaces) including a plurality of tooth flanks including the other-side left tapered tooth flank 121f, the one-side left tapered tooth flank 122b, the other-side right tapered tooth flank 122f, the one-side right tapered tooth flank 121b (subordinate tooth flank) at torsion angles different from the left tooth flank 115b and the right tooth flank 115c (main tooth flanks) on the left side surface 115A and the right side surface 115B (side surfaces) on one side and the other side of the workpiece 115 in the direction of the rotation axis Lw, and the machining tool 42 includes the first cutting blade 42af having the rake face 42cf facing one side of the direction of the rotation axis L of the machining tool 42 and the second cutting blade 42ab having the rake face 42cb facing the other side of the rotation axis L of the machining tool 42.

The first cutting blade 42af is used for machining the other-side left tapered tooth flank 121f and the other-side right tapered tooth flank 122f (subordinate tooth flank) provided on the other side of the workpiece 115Z in the direction of the rotation axis Lw by moving the machining tool 42 relatively with respect to the workpiece 115Z to the other side of the workpiece 115Z in the direction of the rotation axis Lw, and the second cutting blade 42ab is used for machining the one-side left tapered tooth flank 122b and the one-side right tapered tooth flank 121b (subordinate tooth flank) provided on the one side of the workpiece 115Z in the direction of the rotation axis Lw by moving the machining tool 42 relatively with respect to the workpiece 115Z to the one side of the workpiece 115Z in the direction of the rotation axis Lw.

Accordingly, as the gear machining device 1 is capable of forming the other-side left tapered tooth flank 121f, the other-side right tapered tooth flank 122f, the one-side right tapered tooth flank 121b, and the one-side left tapered tooth flank 122b (a plurality of tooth flanks) at different torsion angles on both end surfaces sides of the workpiece 115Z with one machining tool 42, replacement or positional alignment of the two machining tools which used to be required are no longer necessary, and improvement of machining efficiency and enhancement of machining accuracy are achieved.

The blade traces 42bf of the first cutting blade 42af and the blade traces 42bb of the second cutting blade 42ab have the same torsion angle β. Therefore, the costs for the tools may be reduced. In addition, tooth flanks at different torsion angles maybe formed only by changing the intersection angle of the machining tool 42.

Also, a gear machining method for machining a gear with the machining tools 42F (42G, 42, 42L, 42R, 42T), the the tooth 115a of the gear 115 includes the side surface 115A (115B) having the first tooth flank 115b (115c) and the second tooth flank 121 (122) having a torsion angle different from the first tooth flank 115b (115c), and the blade traces 42bf (42bg, 42b, 42bL, 42bR, 42bT) of the cutting blade 42af (42ag, 42a, 42aL, 42aR, 42aT) of the machining tools 42F (42G, 42, 42L, 42R, 42T) having a torsion angle βf (βg, β, βL, βR, βT) determined based on the torsion angle θf (θr, θL, θR) of the second tooth flank 121 (122, 131, 132) and the intersection angles ϕf (ϕg, ϕff, ϕrr, ϕL, ϕR, ϕtr, ϕtf) between the rotation axis Lw of the workpiece 115 and the rotation axis L of the machining tools 42F (42G, 42, 42L, 42R, 42T) so as to allow the second tooth flank 121 (122, 131, 132) to be machined on the pre-machined first tooth flank 115b (115c), the gear machining method including: a step of inclining the rotation axis L of the machining tools 42F (42G, 42, 42L, 42R, 42T) with respect to the rotation axis Lw of the workpiece 115, and a step of machining the second tooth flank 121 (122, 131, 132) by feeding the machining tools 42F (42G, 42, 42L, 42R, 42T) with respect to the workpiece 115 in the direction of the rotation axis Lw while rotating synchronously with the workpiece 115. Accordingly, the same advantageous effects as the above-described gear machining device 1 are achieved.

Also, a gear machining method for cutting a gear with the machining tool 42 having the rotation axis L inclined with respect to the rotation axis Lw of the workpiece 115Z, wherein the left side surface 115A and the right side surface 115B (side surfaces) of the gear tooth respectively include a plurality of tooth flanks including the other-side left tapered tooth flank 121f, the one-side left tapered tooth flank 122b, the other-side right tapered tooth flank 122f, the one-side right tapered tooth flank 121b (subordinate tooth flank) at torsion angles different from the left tooth flank 115b and the right tooth flank 115c (main tooth flanks) on one side and the other side of the left side surface 115A and the right side surface 115B (side surfaces) in the direction of the rotation axis Lw of the gear, and the machining tool 42 includes the first cutting blade 42af having the rake face 42cf facing one side of the direction of the rotation axis L of the machining tool 42 and the second cutting blade 42ab having the rake face 42cb facing the other side of the rotation axis L of the machining tool 42.

The gear machining method includes a first step for moving the machining tool 42 on the other side of the workpiece 115Z in the direction of the rotation axis Lw relatively with respect to the workpiece 115Z in the direction of the rotation axis Lw while rotating synchronously with the workpiece 115Z to machine the other-side left tapered tooth flank 121f and the other-side right tapered tooth flank 122f (subordinate tooth flank) to be provided on the other side of the workpiece 115Z in the direction of the rotation axis Lw with the first cutting blade 42af, and a second step for moving the machining tool 42 on the one side of the workpiece 115Z in the direction of the rotation axis Lw relatively with respect to the workpiece 115Z in the direction of the rotation axis Lw while rotating synchronously with the workpiece 115Z to machine the one-side left tapered tooth flank 122b and the one-side right tapered tooth flank 121b (subordinate tooth flank) to be provided on the one side of the workpiece 115Z in the direction of the rotation axis Lw with the second cutting blade 42ab. Accordingly, the same advantageous effects as the above-described gear machining device 1 are achieved.

The left side surface 115A and the right side surface 115B (side surfaces) of the tooth 115a of the gear include the left tooth flank 115b (fifth tooth flank) as a main tooth flank, the other-side left tapered tooth flank 121f (sixth tooth flank) which is a subordinate tooth flank provided on the left tooth flank 115b (fifth tooth flank) on the other side of the workpiece 115 in the direction of the rotation axis Lw, and the subordinate one-side left tapered tooth flank 122b (seventh tooth flank) provided on the left tooth flank 115b (fifth tooth flank) on one side of the workpiece 115Z in the direction of the rotation axis Lw, the blade traces 42bf of the first cutting blade 42af have a torsion angle β determined based on the torsion angle θf of the other-side left tapered tooth flank 121f (sixth tooth flank) and an intersection angle ϕf between the rotation axis Lw of the workpiece 115Z and the rotation axis L of the machining tool 42 so as to allow the other-side left tapered tooth flank 121f (sixth tooth flank) to be machined on the pre-machined left tooth flank 115b (fifth tooth flank), and the blade traces 42bb of the second cutting blade 42ab have a torsion angle β determined based on the torsion angle θb of the one-side left tapered tooth flank 122b (seventh tooth flank) and an intersection angle ϕb between the rotation axis Lw of the workpiece 115Z and the rotation axis L of the machining tool 42 so as to allow the one-side left tapered tooth flank 122b (seventh tooth flank) to be machined on the pre-machined left tooth flank 115b (fifth tooth flank).

Accordingly, the first cutting blade 42af may be designed into a shape which does not interfere with the tooth 115a adjacent to the left tooth flank 115b (fifth tooth flank) to be machined when machining the other-side left tapered tooth flank 121f (sixth tooth flank), and the second cutting blade 42ab may be designed into a shape which does not interfere with the tooth 115a adjacent to the left tooth flank 115b (fifth tooth flank) to be machined when machining the one-side left tapered tooth flank 122b (seventh tooth flank).

The left side surface 115A (side surface on one side) of the tooth 115a of the gear includes the main left tooth flank 115b (fifth tooth flank), the subordinate other-side left tapered tooth flank 121f (sixth tooth flank) provided on the left tooth flank 115b (fifth tooth flank) on one side of the workpiece 115Z in the direction of the rotation axis Lw, and the subordinate one-side left tapered tooth flank 122b (seventh tooth flank) provided on the left tooth flank 115b (fifth tooth flank) on the other side of the workpiece 115Z in the direction of the rotation axis Lw, and the right side surface 115B (side surface on the other side) of the gear tooth includes the main right tooth flank 115c (eighth tooth flank), the subordinate one-side right tapered tooth flank 121b (ninth tooth flank) provided on the right tooth flank 115c (eighth tooth flank) on one side of the workpiece 115 in the direction of the rotation axis Lw, and the subordinate other-side right tapered tooth flank 122f (tenth tooth flank) provided on the right tooth flank 115c (eighth tooth flank) on the other side of the workpiece 115 in the direction of the rotation axis Lw.

The blade traces 42bf on one side of the first cutting blade 42af have a torsion angle β determined based on the torsion angle θf of the other-side left tapered tooth flank 121f (sixth tooth flank) and an intersection angle ϕf for the sixth tooth flank 121f between the rotation axis Lw of the workpiece 115Z and the rotation axis L of the machining tool 42 so as to allow the other-side left tapered tooth flank 121f (sixth tooth flank) to be machined on the pre-machined left tooth flank 115b (fifth tooth flank), and the blade traces 42bf on the other side of the first cutting blade 42af have the same torsion angle β of the blade traces 42bf on one side of the first cutting blade 42af, the blade traces 42bb on one side of the second cutting blade 42ab have a torsion angle β determined based on the torsion angle θb of the one-side left tapered tooth flank 122b (seventh tooth flank) and an intersection angle ϕb for the one-side left tapered tooth flank 122b (seventh tooth flank) between the rotation axis Lw of the workpiece 115Z and the rotation axis L of the machining tool 42 so as to allow the one-side left tapered tooth flank 122b (seventh tooth flank) to be machined on the pre-machined left tooth flank 115b (fifth tooth flank), and the blade traces 42bb on the other side of the second cutting blade 42ab have the same torsion angle β as the torsion angle β of the blade traces 42bb on one side of the second cutting blade 42ab.

The machining tool 42 is set to an intersection angle ϕf for the other-side left tapered tooth flank 121f (sixth tooth flank) when machining the other-side left tapered tooth flank 121f (sixth tooth flank) with the first cutting blade 42af on the pre-machined left tooth flank 115b (fifth tooth flank), is set to an intersection angle ϕb for the other-side right tapered tooth flank 122f (tenth tooth flank) determined based on the torsion angle ϕb of the other-side right tapered tooth flank 122f (tenth tooth flank) and the torsion angle β of the blade traces 42bf on the other side of the first cutting blade 42af when machining the other-side right tapered tooth flank 122f (tenth tooth flank) with the first cutting blade 42af on the pre-machined right tooth flank 115c (eighth tooth flank), and the machining tool 42 is set to the intersection angle ϕb for the one-side left tapered tooth flank 122b (seventh tooth flank) when machining the one-side left tapered tooth flank 122b (seventh tooth flank) on the pre-machined left tooth flank 115b (fifth tooth flank) with the second cutting blade 42ab, and is set to the intersection angle ϕf for the one-side right tapered tooth flank 121b (ninth tooth flank) determined based on the torsion angle θf of the one-side right tapered tooth flank 121b (ninth tooth flank) and the torsion angle β of the blade traces 42bb on the other side of the second cutting blade 42ab when machining the one-side right tapered tooth flank 121b (ninth tooth flank) with the second cutting blade 42ab on the pre-machined right tooth flank 115c (eighth tooth flank).

Accordingly, the first cutting blade 42af may be designed into a shape which does not interfere with the tooth 115a adjacent to the left tooth flank 115b (fifth tooth flank) to be machined when machining the other-side left tapered tooth flank 121f (sixth tooth flank), and may also be designed into a shape which does not interfere with the tooth 115a adjacent to the right tooth flank 115c (eighth tooth flank) to be machined when machining the other-side right tapered tooth flank 122f (tenth tooth flank). The second cutting blade 42ab may be designed into a shape which does not interfere with the tooth 115a adjacent to the left tooth flank 115b (fifth tooth flank) to be machined when machining the one-side left tapered tooth flank 122b (seventh tooth flank), and may be designed into a shape which does not interfere with the tooth 115a adjacent to the right tooth flank 115c (eighth tooth flank) to be machined when machining the one-side right tapered tooth flank 121b (ninth tooth flank).

In addition, the gear is the sleeve 115Z of the synchromesh mechanism 110A, and the subordinate tooth flanks are the other-side left tapered tooth flank 121f, the one-side left tapered tooth flank 122b, the other-side right tapered tooth flank 122f, and the one-side right tapered tooth flank 121b (tooth flanks) of the gear coming-off preventing portions 120F, 120B provided on an inner teeth of the sleeve 115Z. Accordingly, machining accuracy of the other-side left tapered tooth flank 121f, the one-side left tapered tooth flank 122b, the other-side right tapered tooth flank 122f, and the one-side right tapered tooth flank 121b (tooth flanks) which constitute the gear coming-off preventing portions 120F, 120B is increased by cutting, so that the gear is reliably prevented from coming off.

What is claimed is:

1. A gear machining device comprising:
a machining tool to be used for machining a gear, the machining tool having a rotation axis inclined with respect to a rotation axis of a workpiece and being fed relatively in the direction of the rotation axis of the workpiece while being rotated synchronously with the workpiece, wherein
a gear tooth includes a side surface having a first tooth flank and a second tooth flank having a torsion angle different from the first tooth flank,
the machining tool includes a cutting blade, and the cutting blade has a blade trace having a torsion angle determined based on the torsion angle of the second tooth flank and an intersection angle between the rotation axis of the workpiece and the rotation axis of the machining tool so as to allow the second tooth flank to be machined on the pre-machined first tooth flank.

2. The gear machining device according to claim 1, wherein
the side surface on one side of the gear tooth has the first tooth flank and the second tooth flank having the different torsion angle from the first tooth flank,
the side surface on the other side of the gear tooth has a third tooth flank and a fourth tooth flank having a different torsion angle from the third tooth flank,
the machining tool includes a first machining tool and a second machining tool,
the blade trace of the cutting blade of the first machining tool has a torsion angle determined based on the torsion angle of the second tooth flank and an intersection angle between the rotation axis of the workpiece and a rotation axis of the first machining tool so as to allow the second tooth flank to be machined on the pre-machined first tooth flank, and
the blade trace of the cutting blade of the second machining tool has a torsion angle determined based on the torsion angle of the fourth tooth flank and the intersection angle between the rotation axis of the workpiece and the rotation axis of the second machining tool so as to allow the fourth tooth flank to be machined on the pre-machined third tooth flank.

3. The gear machining device according to claim 1, wherein
the side surface on one side of the gear tooth has the first tooth flank and the second tooth flank having the different torsion angle from the first tooth flank,
the side surface on the other side of the gear tooth has a third tooth flank and a fourth tooth flank having a different torsion angle from the third tooth flank,
the blade trace on one side of the cutting blade of the machining tool has a torsion angle determined based on the torsion angle of the second tooth flank and an intersection angle for the second flank between the rotation axis of the workpiece and the rotation axis of the machining tool so as to allow the second tooth flank to be machined on the pre-machined first tooth flank, and
the blade trace on the other side of the cutting blade of the machining tool has the same torsion angle as the blade trace on the one side of the cutting blade of the machining tool, and
the machining tool is set to an intersection angle for the second tooth flank when machining the second tooth flank on the pre-machined first tooth flank, and is set to an intersection angle for the fourth tooth flank determined based on a torsion angle of the fourth tooth flank and the torsion angle of the blade trace of the cutting blade on the other side of the machining tool when machining the fourth tooth flank on the pre-machined third tooth flank.

4. The gear machining device according to claim 2, wherein
the second tooth flank and the fourth tooth flank are roughly machined by plastic forming, and
the machining tool removes a burr generated on the second tooth flank and the fourth tooth flank when finishing the second tooth flank and the fourth tooth flank.

5. The gear machining device according to claim 3, wherein
the second tooth flank and the fourth tooth flank are roughly machined by plastic forming, and
the machining tool removes a burr generated on the second tooth flank and the fourth tooth flank when finishing the second tooth flank and the fourth tooth flank.

6. The gear machining device according to claim 1, wherein
the gear is a sleeve of a synchromesh mechanism, and
the second tooth flank is a tooth flank of a gear coming-off preventing portion provided on an inner tooth of the sleeve.

7. The gear machining device according to claim 6, wherein the tooth flank of the gear coming-off preventing portion provided on the inner tooth of the sleeve includes a chamfered tooth flank provided on an end surface of the inner tooth of the sleeve and a tapered tooth flank continuing from the chamfered tooth flank.

8. A gear machining device comprising:
a machining tool to be used for machining a gear, the machining tool having a rotation axis inclined with respect to a rotation axis of a workpiece, the machining tool being fed relatively in the direction of the rotation axis of the workpiece while being rotated synchronously with the workpiece, wherein
a gear tooth includes a side surface including a plurality of subordinate tooth flanks having different torsion angles from a main tooth flank respectively thereon on one side and the other side of the workpiece in the direction of the rotation axis,
the machining tool includes: a first cutting blade having a rake face facing one side in the direction of the rotation axis of the machining tool; and furthermore a second cutting blade having a rake face facing the other side in the direction of the rotation axis of the machining tool,
the first cutting blade is used for machining the subordinate tooth flanks provided on the other side of the workpiece in the direction of the rotation axis by moving the machining tool relatively with respect to the workpiece to the other side of the workpiece in the direction of the rotation axis, and
the second cutting blade is used for machining the subordinate tooth flanks provided on the one side of the workpiece in the direction of the rotation axis by moving the machining tool relatively with respect to the workpiece to the one side of the workpiece in the direction of the rotation axis.

9. The gear machining device according to claim 8, wherein
the blade trace of the first cutting blade and the blade trace of the second cutting blade have the same torsion angle.

10. A gear machining method for machining a gear by means of a machining tool,
a gear tooth includes a side surface having a first tooth flank and a second tooth flank having a torsion angle different from the first tooth flank,
the machining tool includes a cutting blade, and the cutting blade has a blade trace having a torsion angle determined based on the torsion angle of the second tooth flank and an intersection angle between the rotation axis of the workpiece and the rotation axis of the machining tool so as to allow the second tooth flank to be machined on the pre-machined first tooth flank,
the gear machining method comprising:
inclining the rotation axis of the machining tool with respect to the rotation axis of the workpiece, and
machining the second tooth flank by feeding the machining tool relatively with respect to the workpiece in the direction of the rotation axis while rotating synchronously with the workpiece.

11. A gear machining method for cutting a gear by means of the machining tool having a rotation axis inclined with respect to a rotation axis of a workpiece,
a gear tooth includes a side surface including a plurality of subordinate tooth flanks having different torsion angles from a main tooth flank respectively on one side and the other side of the workpiece in the direction of the rotation axis,
the machining tool includes: a first cutting blade having a rake face facing one side in the direction of the rotation axis of the machining tool; and furthermore a second cutting blade having a rake face facing the other side in the direction of the rotation axis of the machining tool,
the gear machining method comprising:
a first step of machining the subordinate tooth flanks provided on the other side of the workpiece in the direction of the rotation axis with the first cutting blade by moving the machining tool in the direction of the rotation axis of the workpiece on the other side of the workpiece in the direction of the rotation axis relatively with respect to the workpiece while rotating the machining tool synchronously with the workpiece; and
a second step of machining the subordinate tooth flanks provided on the one side of the workpiece in the direction of the rotation axis with the second cutting blade by moving the machining tool in the direction of the rotation axis of the workpiece on the one side of the workpiece in the direction of the rotation axis relatively with respect to the workpiece while rotating the machining tool synchronously with the workpiece.
